(19) United States
(12) Patent Application Publication
(10) Pub. No.: US 2022/0342911 A1
(43) Pub. Date: Oct. 27, 2022

(54) AUTOMATED DATA SET PROCESSING AND VISUALIZATION FOR MULTI-MODULE PRICING INSIGHTS GRAPHICAL USER INTERFACE

(71) Applicant: PricewaterhouseCoopers LLP, New York, NY (US)

(72) Inventors: Amit DHIR, San Jose, CA (US); Pradnesh DESHMUKH, Mumbai (IN); Vasundhara RUNGTA, Mumbai (IN); Pranati DANG, Bangalore (IN); Aparna PRASANNAN, Mumbai (IN); Vishal ADKAR, Bangalore (IN); Mathew GEORGE, Bangalore (IN)

(73) Assignee: PricewaterhouseCoopers LLP, New York, NY (US)

(21) Appl. No.: 17/579,262

(22) Filed: Jan. 19, 2022

Related U.S. Application Data
(60) Provisional application No. 63/194,708, filed on May 28, 2021.
(60) Provisional application No. 63/180,622, filed on Apr. 27, 2021.

(51) Int. Cl. G06F 16/28; G06F 16/215; G06F 16/25; G06F 16/23; G06F 16/2455

(52) U.S. Cl. CPC G06F 16/287; G06F 16/215; G06F 16/258; G06F 16/2386; G06F 16/24556; G06F 16/2456

(57) ABSTRACT

A method for data ingestion for a data visualization platform comprises receiving a plurality of data sets, generating and storing a merged data set based on the plurality of received data sets, and, receiving, via a graphical user interface, a first input comprising an instruction to perform a data standardization operation. The method comprises, in response to receiving the first input, applying a data standardization operation to the merged data set to process the merged data set to generate a standardized data set. The method comprises receiving, via the interface, a second input comprising an instruction to perform a data analytics operation, and responsively applying the data analytics operation to the standardized data set to generate insights data. The method includes receiving, via the interface, a third input comprising an instruction to perform a data visualization operation, and responsively generating one or more data visualizations based on the insights data.

### CROSS-REFERENCE TO RELATED APPLICATIONS

This application claims the benefit of U.S. Provisional Application No. 63/180,622, filed Apr. 27, 2021, and of U.S. Provisional Application No. 63/194,708, filed May 28, 2021, the entire contents of each of which are incorporated herein by reference.

### FIELD

This disclosure relates generally to systems and methods for automated data set ingestion, processing, and visualization, and relates more specifically to ingestion of pricing data and processing of said pricing data for visualization in a multi-module pricing insights graphical user interface.

### BACKGROUND

Data sets may be incomplete, unstructured, and/or inconsistent for many reasons. An incomplete, unstructured, and/or inconsistent data set may be caused by lack of time and/or knowledge needed to input information. Furthermore, data sets may not be formatted in a manner that is conducive to providing useful and flexible visualizations of said data sets via a graphical user interface.

An incomplete, unstructured, and/or unprocessed data set may cause a number of problems for organizations. Incomplete data sets may be problematic at least because many statistical procedures automatically eliminate data entries which are incomplete; doing so may lead to statistical insignificance and/or misleading results, and/or a reduced confidence in the generated results. Unstructured data sets may be problematic at least because data may not be easily stored in a traditional column-row database or spreadsheet, and thus may not be easily searchable. Unprocessed data sets may be problematic because data (even structured data) that is not properly processed may be difficult or impossible for a human user to decipher or for a graphical user interface to leverage, and patterns and insights that could be gleaned from the data may therefore not be noticed or leveraged. Thus, an incomplete, unstructured, and/or unprocessed data set may increase the difficulty of generating data insights and/or recommendations.

An incomplete, unstructured, and/or unprocessed data set may increase the difficulty of generating data insights, visualizing patterns in data, and/or providing recommendations in a variety of ways. For example, one way to usefully leverage data is to use said data to generate and display one or more data visualizations provided by interactive graphical user interfaces. However, it may prove infeasible to apply visualization operations to incomplete, unstructured, and/or unprocessed data sets. Furthermore, an incomplete or unstructured data may increase time to insights, thereby obstructing quick decision making.

### SUMMARY

As explained above, incomplete, unstructured, and/or unprocessed data sets may increase the difficulty of generating data insights, visualizing patterns in data, and/or providing recommendations in a variety of fields. For example, incomplete unstructured, and/or unprocessed data set in business settings may cause analysts and salespersons to implement pricing strategies that are not properly optimized. Thus, there is a need for techniques for automatically ingesting data sets, combining ingested data sets, standardizing data, processing data, and visualizing data in an automated and/or semi-automated fashion. Furthermore, there is a need to provide these functionalities to users in an interactive manner that allows users to control the application of one or more of the functionalities via a graphical user interface for interacting with the underlying data and for viewing visualizations generated in accordance with the data and in accordance with user inputs. Furthermore, there is a need to provide these functionalities in a repeatable and/or iterative manner, such that generating insights is not a one-time activity, but can be done quickly and adaptively.

Disclosed herein are systems, methods, and graphical user interfaces that may address one or more of the above-identified needs. In some embodiments, a system for automated and/or semi-automated data ingestion, data processing, and data visualization is provided. The system may be configured to ingest data sets from a plurality of disparate data sources and combine the received data sets into a merged data set. The system may then be configured to apply one or more standardization operations to the merged data set to generate a standardized data set. The system may then be configured to apply one or more data analytics operations to the standardized data set in order to generate insights data. The system may then be configured to apply one or more data visualization operations to said insights data in order to generate and provide (e.g., display) one or more data visualizations that may be viewed and interacted with by a user.

The system may provide a graphical user interface via which a user may view the one or more displayed data visualizations. The graphical user interface may further enable users to execute one or more inputs to control the data merging operations, data standardization operations, data analytics operations, and/or data visualization operations of the system.

In some embodiments, the systems, methods, and graphical user interfaces disclosed herein may be applied to ingesting and processing pricing data for use in analyzing and visualizing pricing information for a business. In some embodiments, the graphical user interface may include a plurality of modules each configured to afford different functionalities and different visualizations to end users. In some embodiments, the graphical user interface may include a first module configured to display information regarding pricing performance across a deal level, a customer level, and a product level represented in the underlying data; a second module configured to display information regarding one or more customers represented in the underlying data; a third module configured to display information regarding one or more products represented in the underlying data; a fourth graphical user interface module configured to display information regarding one or more deals represented in the underlying data; a fifth graphical user interface module configured to display information regarding one or more off-invoice incentives represented in the underlying data; and a sixth graphical user interface module configured to display information regarding one or more customer segments represented in the underlying data.

In some embodiments, a method for data ingestion for a data visualization platform is provided, the method comprising: receiving a plurality of data sets, wherein a first data set of the plurality of data sets is received from a first data source and wherein the second data set of the plurality of data sets is received from a second data source; generating and store a merged data set based on the plurality of received data sets; causing display of a graphical user interface configured to receive user instructions for data processing; receiving, via the graphical user interface, a first input comprising an instruction to perform one or more data standardization operations; in response to receiving the first input, applying the one or more data standardization operations to the merged data set to process the merged data set to generate a standardized data set; receiving, via the graphical user interface, a second input comprising an instruction to perform one or more data analytics operations; in response to receiving the second input, applying the one or more data analytics operations to the standardized data set to generate insights data; receiving, via the graphical user interface, a third user input comprising an instruction to perform one or more data visualization operations; and in response to receiving the third input, generating one or more data visualizations based on the insights data, wherein the data visualization includes an association visualization, wherein the association visualization depicts a plurality of association scores between a plurality of pairs of entities, wherein each of the plurality of pairs of entities includes a first entity in a first set of entities and a second entity in a second set of entities, and wherein the association visualization depicts a respective association score for each pair of the plurality of pairs of entities.

In some embodiments of the method: the first input comprising an instruction to perform one or more data standardization operations comprises an instruction to perform a data mapping operation; and applying the one or more data standardization operations comprises applying the data mapping operation to the merged data set.

In some embodiments of the method, applying the data mapping operation to the merged data set comprises mapping one or more data objects in the merged data set to a predefined data format.

In some embodiments of the method: the instruction to perform a data mapping operation comprises a specification of a characteristic of a user-defined data format; and applying the data mapping operation to the merged data set comprises mapping one or more data objects in the merged data set to the user-defined data format in accordance with the specification of the characteristic of the user-defined data format.

In some embodiments of the method, mapping one or more data objects in the merged data set to the user-defined data format comprises generating one or both of a wide-form data set and a long-form data set.

In some embodiments of the method, applying the one or more data standardization operations comprises applying one or more roll-up operations to the merged data set.

In some embodiments of the method, applying the one or more data standardization operations comprises applying one or more join operations to the merged data set.

In some embodiments of the method, generating the merged data set based on the plurality of received data sets comprises applying one or more data cleaning operations one or more data objects in the plurality of received data sets.

In some embodiments of the method, generating the merged data set based on the plurality of received data sets comprises applying one or more data aggregation operations to one or more data objects in the plurality of received data sets to join the plurality of data sets.

In some embodiments of the method, applying the one or more data analytics operations comprises applying one or more segmentation operations to segment the merged data set.

In some embodiments of the method: the second input comprises a selection of a predefined rule; and applying the one or more data analytics operation comprises applying the predefined rule.

In some embodiments of the method: the second input comprises an instruction to define a user-defined rule; and applying the one or more data analytics operation comprises applying the user-defined rule.

In some embodiments of the method, the method further comprises: receiving updated data for one or more of the plurality of data sets; in response to receiving the updated data, automatically updating the one or more data visualizations based on the data insights data based on the received updated data.

In some embodiments of the method, the method further comprises: receiving updated data for one or more of the plurality of data sets; in response to receiving the updated data, automatically updating the merged data set based on the received updated data.

In some embodiments of the method, receiving the updated data comprises performing a scheduled batch update operation.

In some embodiments of the method, the first set of entities includes one or more product families, one or more products, or one or more SKU's.

In some embodiments of the method, the second set of entities includes one or more product families, one or more products, or one or more SKU's.

In some embodiments of the method: the first set of entities is depicted in the data visualization along a first axis, the second set of entities is depicted in the data visualization along a second axis; the first set of entities and the second set of entities define a plurality of intersecting regions in a grid; and each of the plurality of intersection regions includes a respective depiction of a respective one of the association scores.

In some embodiments of the method, the respective depictions include an alphanumeric depiction of the respective association score.

In some embodiments of the method, the respective depiction includes one or more of a color-coding or a shading determined in accordance with the respective association score.

In some embodiments of the method, one or more entities in the first set of entities or one or more entities in the second set of entities is selected in accordance with the third user input.

In some embodiments of the method, the third user input indicates a criteria based on which the one or more entities in the first set of entities or one or more entities in the second set of entities is automatically selected.

In some embodiments of the method, each association score is calculated based on one or more of customer overlap and order overlap.

In some embodiments of the method, each association score is calculated as a respective quotient, wherein each quotient comprises a respective numerator representing an intersection of a respective pair of entities and each quotient comprises a respective denominator representing a union of the respective pair of entities.

In some embodiments, a system for data ingestion for a data visualization platform is provided, the system comprising one or more processors configured to cause the system to: receive a plurality of data sets, wherein a first data set of the plurality of data sets is received from a first data source and wherein the second data set of the plurality of data sets is received from a second data source; generate and store a merged data set based on the plurality of received data sets; cause display of a graphical user interface configured to receive user instructions for data processing; receive, via the graphical user interface, a first input comprising an instruction to perform one or more data standardization operations; in response to receiving the first input, applying the one or more data standardization operations to the merged data set to process the merged data set to generate a standardized data set; receiving, via the graphical user interface, a second input comprising an instruction to perform one or more data analytics operations; in response to receiving the second input, applying the one or more data analytics operations to the standardized data set to generate insights data; receiving, via the graphical user interface, a third user input comprising an instruction to perform one or more data visualization operations; and in response to receiving the third input, generating one or more data visualizations based on the insights data, wherein the data visualization includes an association visualization, wherein the association visualization depicts a plurality of association scores between a plurality of pairs of entities, wherein each of the plurality of pairs of entities includes a first entity in a first set of entities and a second entity in a second set of entities, and wherein the association visualization depicts a respective association score for each pair of the plurality of pairs of entities.

In some embodiments, a non-transitory computer-readable storage medium storing instructions for data ingestion for a data visualization platform is provided, the instructions configured to be executed by one or more processors of a system to cause the system to: receive a plurality of data sets, wherein a first data set of the plurality of data sets is received from a first data source and wherein the second data set of the plurality of data sets is received from a second data source; generate and store a merged data set based on the plurality of received data sets; cause display of a graphical user interface configured to receive user instructions for data processing; receive, via the graphical user interface, a first input comprising an instruction to perform one or more data standardization operations; in response to receiving the first input, applying the one or more data standardization operations to the merged data set to process the merged data set to generate a standardized data set; receiving, via the graphical user interface, a second input comprising an instruction to perform one or more data analytics operations; in response to receiving the second input, applying the one or more data analytics operations to the standardized data set to generate insights data; receiving, via the graphical user interface, a third user input comprising an instruction to perform one or more data visualization operations; and in response to receiving the third input, generating one or more data visualizations based on the insights data, wherein the data visualization includes an association visualization, wherein the association visualization depicts a plurality of association scores between a plurality of pairs of entities, wherein each of the plurality of pairs of entities includes a first entity in a first set of entities and a second entity in a second set of entities, and wherein the association visualization depicts a respective association score for each pair of the plurality of pairs of entities.

In some embodiments, a system for data visualization is provided, the system comprising: memory storing a one or more data sets; one or more processors configured to cause the system to: cause display of a graphical user interface configured to accept user inputs for generating data visualizations; detect a first input, executed via the graphical user interface, the first input comprising an instruction to display a first data visualization based on the data set, in response to detecting the first user input, cause display via the graphical user interface of the first data visualization based on the data set, wherein the graphical user interface comprises a graphical user interface module selected from the group of: a first graphical user interface module configured to display information regarding pricing performance across a deal level, a customer level, and a product level represented in the one or more data sets; a second graphical user interface module configured to display information regarding one or more deals represented in the one or more data sets; a third graphical user interface module configured to display information regarding one or more customers represented in the one or more data sets; a fourth graphical user interface module configured to display information regarding one or more products represented in the one or more data sets, wherein the fourth graphical user interface module is configured to display a data visualization including an association visualization, wherein the association visualization depicts a plurality of association scores between a plurality of pairs of entities, wherein each of the plurality of pairs of entities includes a first entity in a first set of entities and a second entity in a second set of entities, and wherein the association visualization depicts a respective association score for each pair of the plurality of pairs of entities; a fifth graphical user interface module configured to display information regarding one or more off-invoice incentives represented in the data; and a sixth graphical user interface module configured to display information regarding one or more customer segments represented in the data.

In some embodiments of the system, the first graphical user interface module comprises one or more graphical user interface dashboards selected from the group of: a data profile dashboard configured to display summary information displayed according to one or more of region, time period, product, family, channel, customer, and sales representative; a price element benchmark dashboard configured to display one or more of price waterfall benchmark information and market development fund benchmark information; a price waterfall and what-if analysis dashboard configured to accept scenario inputs from a user defining scenario constraints and to display a price waterfall visualization that is generated in accordance with the scenario inputs; an insights dashboard configured to display information indicating one or more realization parameters calculated based on the one or more data sets and one or more user inputs; and a discount analysis dashboard configured to display visualizations of one or more variations of discounts based on a plurality of categorical attributes.

In some embodiments of the system, the second graphical user interface module comprises one or more graphical user interface dashboards selected from the group of: a deal performance dashboard configured to accept deal parameter inputs and to generate a deal categorization visualization based on the deal parameter inputs; and a deal details dashboard configured to accept deal filtering inputs and to generate a deal details visualization based on the deal filtering inputs.

In some embodiments of the system, the third graphical user interface module comprises one or more graphical user interface dashboards selected from the group of: a customer performance dashboard configured to display information, based on the one or more data sets, comprising one or more of total revenue by country for a customer, monthly trends for a customer, top customers, bottom customers, and product-level information for a customer; a Pareto analysis dashboard configured to display a Pareto chart visualization for one or more of list price, invoice revenue, pocket price, and pocket margin, wherein the Pareto chart is generated based on the one or more data sets; a customer classification matrix dashboard configured to display a matrix visualization of customer data, based on the one or more data sets, wherein the matrix visualization is generated in accordance with one or more key performance indicators; a customer revenue/margin details dashboard configured to display a bubble chart based of customer data, based on the one or more data sets, wherein the bubble chart is generated in accordance with one or more of invoice revenue data and margin percentage data; and a revenue change dashboard configured to display a visualization of revenue change data, based on the one or more data sets, for one or both of a sales representative and a customer.

In some embodiments of the system, the fourth graphical user interface module comprises one or more graphical user interface dashboards selected from the group of: a product performance dashboard configured to accept product selection inputs and to generate one or more product visualizations based on the one or more data sets and the product selection inputs; a product price variance dashboard configured to display a price variability visualization based on the one or more data sets; a product price and cost trends dashboard configured to display a product price and cost trends visualization, based on the one or more data sets, of one or more of price, cost, revenue, and fluctuations thereof for one or more products and; a product profitability dashboard configured to display a profitability visualization, based on the one or more data sets; a product channel price dashboard configured to display a channel visualization comparing one or more price metrics for a plurality of channels, wherein the channel visualization is generated based on the one or more data sets; and a product upsell dashboard configured to display information indicating inter-product associations between two or more products, wherein said information indicating inter-product associations is based on the one or more data sets, wherein said information indicating inter-product associations includes the association visualization.

In some embodiments of the system, the fifth graphical user interface module comprises one or more graphical user interface dashboards selected from the group of: a contra summary dashboard configured to display market development fund summary information and rebate summary information, wherein the market development fund summary information and the rebate summary information are based on the one or more data sets; a market development fund performance summary dashboard configured to display, based on the one or more data sets, one or both of market development fund allocation information and market development fund spend information; a distributor market development fund assessment dashboard configured to display, based on the one or more data sets, one or both of market development fund allocation information and market development fund spend information for a distributor; a distributor activity effectiveness dashboard configured to display, based on the one or more data sets, market development fund spend information across one or more activities for a distributor; a reseller market development fund assessment dashboard configured to display, based on the one or more data sets, one or both of market development fund allocation information and market development fund spend information for a reseller; a reseller activity assessment dashboard configured to display, based on the one or more data sets, market development fund spend information across one or more activities for a reseller; a rebates performance summary dashboard configured to display, based on the one or more data sets, one or more of: rebate information pertaining to one or more channels, rebate information pertaining to one or more partners, rebate trend information for a time period, top compensated accounts, top compensated products, and top compensated programs; a rebates effectiveness dashboard configured to display, based on the one or more data sets, a visualized comparison for a plurality of rebate types; a rebates category dashboard configured to display, based on the one or more data sets, a visualized comparison for planned rebates versus actual rebates; and a rebates scenario analysis dashboard configured to accept a rebate scenario input from a user and to generate and display, based on the one or more data sets and based on the rebate scenario input, a vitalization of rebate scenario information.

In some embodiments of the system, the sixth graphical user interface module comprises one or more graphical user interface dashboards selected from the group of: a data profile dashboard configured to display data summary information, based on the one or more data sets, wherein the data summary information is visualized in accordance with one or more of geography, country, industry, channel, product family, account type, and end user category; a segments overview dashboard configured to accept one or more segments profiling inputs and to generate a segments profiling visualization, wherein the segments profiling visualization is based on the one or more data sets and on the one or more segments profiling inputs; a segments matrix dashboard configured to display a segments matrix visualization that visualizes segments, based on the one or more data sets, in accordance with invoice revenue and pocket margin; a segment details dashboard configured to display account-segment comparison information, based on the one or more data sets, wherein the account-segment comparison information compares at least one account to a segment into which the at least one account is categorized; a white space analysis dashboard configured to display a white space visualization generated based on the one or more data sets.

In some embodiments, a method for data visualization is provided, the method performed at a system comprising a memory storing one or more data sets and comprising a processor, the method comprising: causing display of a graphical user interface configured to accept user inputs for generating data visualizations; detecting a first input, executed via the graphical user interface, the first input comprising an instruction to display a first data visualization based on the data set, in response to detecting the first user input, causing display via the graphical user interface of the first data visualization based on the data set, wherein the graphical user interface comprises a graphical user interface module selected from the group of: a first graphical user interface module configured to display information regarding pricing performance across a deal level, a customer level, and a product level represented in the one or more data sets; a second graphical user interface module configured to display information regarding one or more deals represented in the one or more data sets; a third graphical user interface module configured to display information regarding one or more customers represented in the one or more data sets; a fourth graphical user interface module configured to display information regarding one or more products represented in the one or more data sets, wherein the fourth graphical user interface module is configured to display a data visualization including an association visualization, wherein the association visualization depicts a plurality of association scores between a plurality of pairs of entities, wherein each of the plurality of pairs of entities includes a first entity in a first set of entities and a second entity in a second set of entities, and wherein the association visualization depicts a respective association score for each pair of the plurality of pairs of entities; a fifth graphical user interface module configured to display information regarding one or more off-invoice incentives represented in the data; and a sixth graphical user interface module configured to display information regarding one or more customer segments represented in the data.

In some embodiments, a non-transitory computer-readable storage medium storing instructions for data visualization is provided, the instructions configured to be executed by one or more processors of a system comprising a memory storing one or more data sets, the instructions configured to cause the system to: cause display of a graphical user interface configured to accept user inputs for generating data visualizations; detect a first input, executed via the graphical user interface, the first input comprising an instruction to display a first data visualization based on the data set, in response to detecting the first user input, cause display via the graphical user interface of the first data visualization based on the data set, wherein the graphical user interface comprises a graphical user interface module selected from the group of: a first graphical user interface module configured to display information regarding pricing performance across a deal level, a customer level, and a product level represented in the one or more data sets; a second graphical user interface module configured to display information regarding one or more deals represented in the one or more data sets; a third graphical user interface module configured to display information regarding one or more customers represented in the one or more data sets; a fourth graphical user interface module configured to display information regarding one or more products represented in the one or more data sets, wherein the fourth graphical user interface module is configured to display a data visualization including an association visualization, wherein the association visualization depicts a plurality of association scores between a plurality of pairs of entities, wherein each of the plurality of pairs of entities includes a first entity in a first set of entities and a second entity in a second set of entities, and wherein the association visualization depicts a respective association score for each pair of the plurality of pairs of entities; a fifth graphical user interface module configured to display information regarding one or more off-invoice incentives represented in the data; and a sixth graphical user interface module configured to display information regarding one or more customer segments represented in the data.

In some embodiments, any one or more of the features or aspects of any of the embodiments recited above may be combined in whole or in part with one another, and/or may be combined in whole or in part with any other feature or aspect disclosed herein.

### BRIEF DESCRIPTION OF THE DRAWINGS

Various embodiments are described with reference to the accompanying figures, in which:

FIG. 1 depicts a system architecture of a data set processing and visualization system, according to some embodiments;

FIGS. 2A-2B depict a flowchart of a method for using a data set processing and visualization system, according to some embodiments;

FIG. 3 depicts a flowchart of a method for using a data set processing and visualization system, according to some embodiments;

FIGS. 4A-4AH show various dashboards of a multi-module graphical user interface provided by a graphical user interfaces for data set processing and visualization, according to some embodiments;

FIGS. 5A-5C depict data processing and visualization techniques, in accordance with some embodiments; and

FIG. 6 illustrates a computing device, according to some embodiments.

### DETAILED DESCRIPTION

Disclosed herein are systems, methods, and graphical user interfaces for automated and/or semi-automated data ingestion, data processing, and data visualization is provided. The system may be configured to ingest data sets from a plurality of disparate data sources and combine the received data sets into a merged data set. The system may then be configured to apply one or more standardization operations to the merged data set to generate a standardized data set. (In some embodiments, data standardization may take place prior to and/or post data merging.) The system may then be configured to apply e or more data analytics operations to the standardized data set in order to generate insights data. The system may then be configured to apply one or more data visualization operations to said insights data in order to generate and provide (e.g., display) one or more data visualizations that may be viewed and interacted with by one or more users, including simultaneous interaction by multiple users through one or more different screens and/or devices interacting with a graphical user interface.

The system may provide a graphical user interface via which a user may view the one or more displayed data visualizations. The graphical user interface may further enable users to execute one or more inputs to control the data merging operations, data standardization operations, data analytics operations, and/or data visualization operations of the system.

In some embodiments, the systems, methods, and graphical user interfaces disclosed herein may be applied to ingesting and processing pricing data for use in analyzing and visualizing pricing information for a business. In some embodiments, the graphical user interface may include a plurality of modules each configured to afford different functionalities and different visualizations to end users (including multiple different end-users with different roles and permissions, such as c-suite users and/or sales representatives). In some embodiments, the graphical user interface may include a first module configured to display information regarding pricing performance across a deal level, a customer level, and a product level represented in the underlying data; a second module configured to display information regarding one or more customers represented in the underlying data; a third module configured to display information regarding one or more products represented in the underlying data; a fourth graphical user interface module configured to display information regarding one or more deals represented in the underlying data; a fifth graphical user interface module configured to display information regarding one or more off-invoice incentives represented in the underlying data; and a sixth graphical user interface module configured to display information regarding one or more customer segments represented in the underlying data.

In some embodiments, the systems and methods described herein may provide a collection of methods and a system for executing diagnostic assessments and/or pricing assessments for a client, such that the client may provide one or more exports of transaction data, products data, accounts data, contra data, and the like, and the data may be processed in an automated and reusable manner in accordance with the methods described herein in order to generate one or more interactive visualizations for a user and/or client to consume.

In some embodiments, the systems and methods described herein may provide a user interface that includes a plurality of modules, including for example: an executive module (e.g., a module including one or more price waterfall visualizations and/or one or more “what-if” functionalities, as described herein), a customer module, a product module, a deal module, a contra module, and a segmentation module. Each of the modules may provide respective functionalities and visualizations to users, as described herein.

In some embodiments, one or more of the systems described herein may be configured to perform an association analysis on ingested data and/or to provide an association analysis GUI screens (e.g., dashboards) (including one or more visualizations thereof) that visualize information pertaining to products that are frequently bought together. Users of the system may thus be enabled to quickly identify bundles to be targeted to prospective customers, which may dictate policies regarding product bundling and product cross-selling to increase revenue. In some embodiments, data resulting from an association analysis may be leveraged by one or more of the modules and/or dashboards described herein.

In some embodiments, one or more of the systems described herein may be configured to provide one or more dynamic price waterfall visualizations generated based on ingested and/or processed data. A dynamic price waterfall visualization may be scoped at a product level, account level, and/or sales representative level. A dynamic price waterfall visualization may be configured such that different discount strategies can be simulated based on underlying data and user inputs. Resulting improvements in revenue and margins can thus be readily viewed for various geographies, sales representatives, accounts, and/or product families.

In some embodiments, one or more of the systems described herein may be configured to perform segmentation analysis on ingested data and/or to provide a GUI dashboard (including one or more visualizations) that visualizes segmentation information. Segmentation information may display information regarding segmentation analysis of customers and/or deals. In some embodiments, a willingness-to-pay (WTP) analysis (e.g., one or more algorithms and/or one or more machine learning models) may be applied to segment ingested data, for example by segmenting customers according to calculated predicted willingness to pay.

In some embodiments, one or more of the systems described herein may be configured to perform one or more benchmarking analyses based on ingested data. For example, one or more graphical user interface dashboards for price and volume trend analyses may provide analysis such as time-series modelling, prediction to identify patterns, and assessed reasons for margin leakage. This may provide a holistic picture that users can use to design optimal pricing policies. Internal benchmarking provided by the systems disclosed herein may also enable users to perform price setting exercises. For example, users may be able to zoom into one or more price trends displayed in a visualization for a particular geography, channel, or the like, and the user may thus identify trends over time for that data subset. Discounts analysis through interactive price waterfall visualizations may simulate improvement figures and set prices for a particular product use case. In some embodiments, data generated using one more benchmarking analyses may be used across one or more different modules, such as a deal module, customer module, and/or product module as disclosed herein.

In some embodiments, one or more individual elements of a price waterfall visualization, including channel partner incentives, may be compared against industry benchmark information. In some embodiments, the system may identify gaps between a company and industry benchmark data. In some embodiments, benchmark data may be based on public data, survey data, and/or ingested data that has been anonymized. In some embodiments, survey data may be leveraged using one or more conjoint survey techniques.

In some embodiments, one or more of the systems described herein may be configured to perform one or more price erosion analyses based on ingested data. These analyses may identify loss of product pricing over time for global, region-specific, and/or account-specific levels. These trends can be further analyzed for particular sales representatives and/or channel partners. In some embodiments, a price erosion analysis may be a type of time series analysis.

In some embodiments, one or more of the systems described herein may be configured to generate and provide, based on ingested data, one or more recommended actions. For example, the system may be configured to identify particular accounts, examine price waterfall and product portfolio for the particular accounts, and provide rapid and specific recommendations regarding margins, pricing aggressiveness, specific discount reductions or increases, actions to arrest margin leakage, and/or actions to increase product breadth. In some embodiments, the system may be configure to provide functionality for fixing or firing one or more accounts. The interplay of internal benchmarking and price waterfall visualizations may provide very specific account-level pricing recommendations.

In some embodiments, one or more of the systems described herein may be configured to generate and provide, based on ingested data, one or more price erosion analyses. A consistent loss of product pricing, which may be referred to as price erosion, may drag down margins across a firm. In cases where prices are increased and adjusted to market conditions continually, there may be situations in which a firm cannot net the price increase due to suboptimal and/or ad-hoc discounts. The systems disclosed herein may provide visualizations that identify and demonstrate such situations, and may perform analysis and visualization over several time periods to gauge effectiveness and translation of price increases and to demonstrate the effect of price changes on revenue and margin leakage. This analysis may dictate pricing actions for users. In some embodiments, a trend analysis dashboard of a graphical user interface may provide time series modeling and/or prediction to identify patterns in prices and/or margins over time, which may be used to demonstrate and/or generate and output pricing recommendations.

In some embodiments, one or more of the systems described herein may be configured to generate and provide, based on ingested data, one or more bundling analyses. For firms selling numerous products, there may be certain product groups frequently purchased together by customers. This may provide an opportunity to identify patterns regarding products that are frequently bought together. The system may provide an association analysis that suggests potential bundles (e.g., product bundles) based on ingested data. In some embodiments, an association analysis may be performed by generating one or more association scores, for example using a statistical score technique and/or a Bayesian score technique. Once product bundles are identified, users can mobilize cross-sell and up-sell opportunities for targeted customers.

In some embodiments, one or more of the systems described herein may be configured to generate and provide, based on ingested data, one or more scenario modeling functionalities. A user may be able to specify one or more criteria for a scenario, and the system may compute outcomes, based on the user-specified criteria and the ingested data, for the scenario. Users can apply scenario modeling functionality in order to examine and evaluate various discounting reductions and quickly view outputs regarding potential improvements in products and accounts. In some embodiments, the system may provide display and/or visualization of price waterfall information for scenario modeling, including information from list price to pocket margin, which may enable scenario analysis through interactive cross-dashboard (e.g., cross-GUI-dashboard actions that may reveal revenue and margin opportunities). In some embodiments, the system may provide display and/or visualization of “what-if” analyses for scenario modeling, which may allow a user to specify one or more discount reductions for one or more price waterfall elements and to instantly view the effectiveness on improvement in invoice revenue and/or pocket margin across the organization. In this way, users can uniquely assess future opportunities by geographical areas, account, product families, and/or by individual sales representative. Price changes for scenario modeling may be indicated and/or visualized for various levels of splits and compared across various time-periods (e.g., quarters, years).

In accordance with the systems, methods, and graphical user interfaces disclosed herein, companies may be enabled to implement effective pricing strategies that overcome problems caused by lack of analytics and insights. As a result, companies may avoid using ad-hoc pricing strategies that can lead to margin/revenue leakage, inconsistent prices in the market, longer deal cycle times, and customer churn.

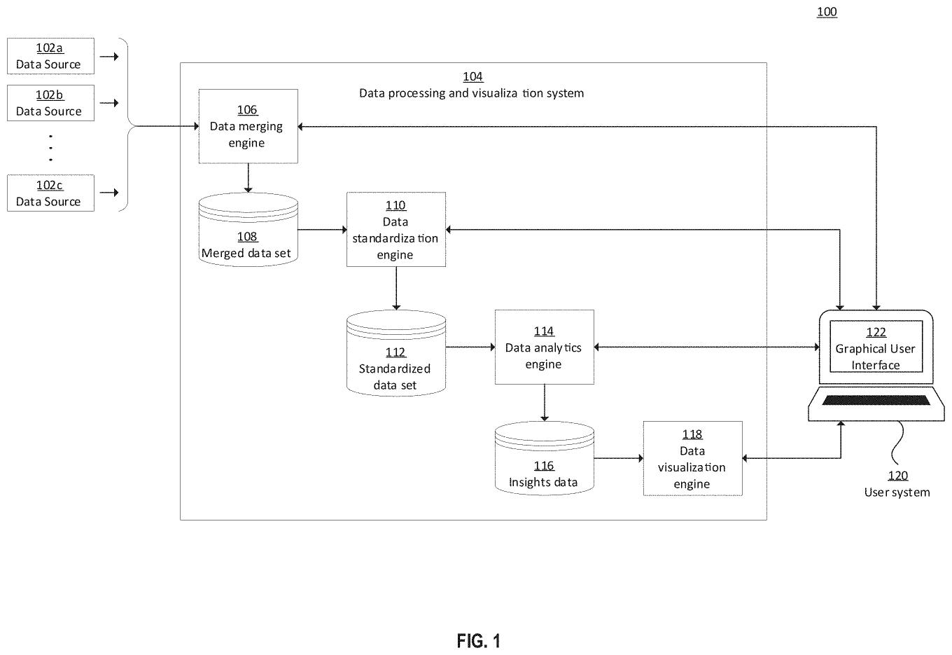

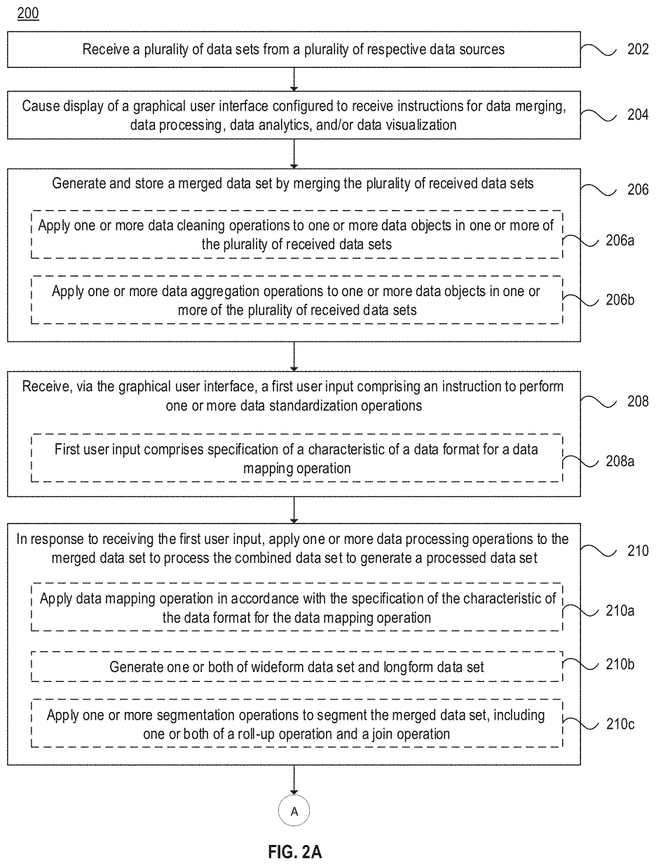

FIG. 1 depicts a system architecture of a data set processing and visualization system 100, according to some embodiments. System 100 is an electronic system configured to process one or more data sets, to generate and store one or more processed data sets, and to generate and display one or more data visualizations based on said data, as described herein. System 100 may include data sources 102a-102c, data processing and visualization system 104, and user system 120, each of which may be communicatively coupled with one another, for example as shown in FIG. 1. As described herein, system 104 may be configured to receive a plurality of data sets from one or more of data sources 102a-102c, process said received data sets, and generate one or more visualizations based on said data sets for display via graphical user interface 122 on user system 120.

Data sources 102a-102c (in some embodiments, the number of data sources 102 in system 100 may be any suitable number, including one, two, or three or more) may be any data source or data store configured to provide data to system 104, for example via wired or wireless network communication. One or more of data sources 102 may include one or more suitable computer storage mediums. In some embodiments, a data source 102 may provide a respective data set, or may provide a plurality of respective data sets, that are stored on the respective data source and/or transmitted by the respective data source to system 104. In some embodiments, the data sets provided by data sources 102 may include data pertaining to one or more entities, organizations, products, product families, prices, profits, margins, other financial metrics, regions, countries, salespeople, customers, and/or any groups thereof, trends thereamong, and/or characteristics thereof. In some embodiments, one or more of data sources 102 may comprise one or more databases which organize stored data sets. One or more of the databases may support data structures such as strings, integers, hashes, tables, arrays, lists, tuples, stacks, queues, sets, bitmaps, trees, graphs, any combination thereof, or the like. In some embodiments, one or more of data sources 102 may be an internal database of a company or an external database (e.g., comprising customer data pertaining to one or more customer surveys).

In some embodiments, one or more data sets may be ingested from one or more of data sources 102 to system 104. For example, a cloud-based web-application may connect to and pull data from data sources 102. In some embodiments, data may be ingested from data sources 102 via an Apache Hadoop Distributed File System (HDFS) and/or via Microsoft Windows Azure Storage Blob (WASB). In some embodiments, additionally or alternatively to data sources 102, data may be ingested directly from a platform (e.g., Salesforce's Customer Relationship Management (CRM) platform and/or Salesforce's Configure, Price, Quote (CPQ) platform) to system 104 (e.g., via one or more APIs).

In some embodiments, system 104 may comprise any one or more computer processors configured to receive, process, generate, and/or transmit data. System 104 may further include one or more computer storage devices (e.g., memories, databases, or the like) configured to store received and/or generated data. System 104 may be provided as one or more local computer systems, one or more servers, a distributed computing system, and/or a cloud computing system.

As shown in FIG. 1, data ingested by system 104 from data sources 102 may be processed by one or more data processing engines of system 104. As shown, system 104 may include data merging engine 106 (which may alternately be referred to as a data aggregation engine), data standardization engine 110, data analytics engine 114, and data visualization engine 118, each of which may include or be provided by one or more processors of system 104 configured to receive data, process data, and generate and output processed data. In some embodiments, a data cleaning engine may also be included. Although the data processing engines 106, 110, 114, and 118 are shown in FIG. 1 as distinct elements, two or more of them (and or two or more of any other engines) may in some embodiments be provided by one or more of the same processors (e.g., they may be provided as a single processor, server, engine, or the like).

As described in greater detail herein, the data processing engines 106, 110, 114, and 118 may in some embodiments be configured to collectively form a data processing pipeline, such that one of the engines may process data and generate output data, which may in turn be further processed by a subsequent one or more of the engines. In the example shown in FIG. 1, data merging engine 108 may process the plurality of data sets received from data sources 102 to apply one or more data merging operations and to thereby generate merged data set 108; data standardization engine 110 may process merged data set 108 to apply one or more data standardization operations and to thereby generate standardized data set 112; data analytics engine 114 may process standardized data set 112 to apply one or more data analytics operations and to thereby generate insights data 116; and data visualization engine 118 may process insights data 116 in order to generate one or more visualizations to be displayed via graphical user interface 122 on user system 120.

Each of the data sets 108, 112, and 116 may be stored, separately or in combination with one another and/or with one or more other data sets, in any suitable computer storage, database, or the like, as part of or in association with system 104.

In some embodiments, user system 120 may be any suitable user device including, for example, a desktop computer, laptop computer, workstation, touch-screen device, mobile electronic device, tablet, or the like. User system 120 may be communicatively coupled to system 104 and may be configured to receive instructions from system 104 for providing graphical user interface 122, for example by receiving instructions for displaying one or more visualizations generated by visualization engine 118 based on insights data 116.

In some embodiments, user system 120 may be configured to accept one or more user inputs, via graphical user interface 122, which may indicate instructions for applying one or more data processing operations by system 104. User system 120 may transmit data to system 104 in accordance with the one or more user inputs received, and system 104 may apply one or more of the data processing operations in accordance with the instructions indicated by the user inputs via graphical user interface 122 and user system 120. In this way, graphical user interface 122 may allow users to interact with data via system 100 in an interactive manner, such that the data may be processed and visualized in accordance with preferences and parameters specified by the user. In some embodiments, graphical user interface 122 may be provided by a desktop application, mobile application, webpage, and/or web browser interface.

In some embodiments, user system 120 may be a user device associated with an analyst, salesperson, manager, or administrator of system 100. In some embodiments, user system 120 may be associated with a permission setting to access and/or provide inputs to one or more dashboards of graphical user interface 122. A dashboard of the graphical user interface may be associated with a specific function of the system. For example, in some embodiments, user system 120 may have permission to access all dashboards, and thus have permission to control data merging, data standardization, data analytics, and data visualization functionalities of the system. Contrastingly, in some embodiments, user system 120 may have permission to access only a subset of dashboards (e.g., those dashboards associated with data analytics and data visualization), and thus have permission to control only a subset of functionalities of the system. Different permission levels may be set for user system 120 in accordance with the role (e.g., analyst, salesperson, manager, administrator, etc.) of a user of user system 120.

While FIG. 1 shows the various data processing operations being applied in an exemplary order, a person of ordinary skill in the art will understand, in light of the disclosure herein, that one or more of the data processing operations may be performed alone and/or in combination with one or more of the other operations in any suitable order.

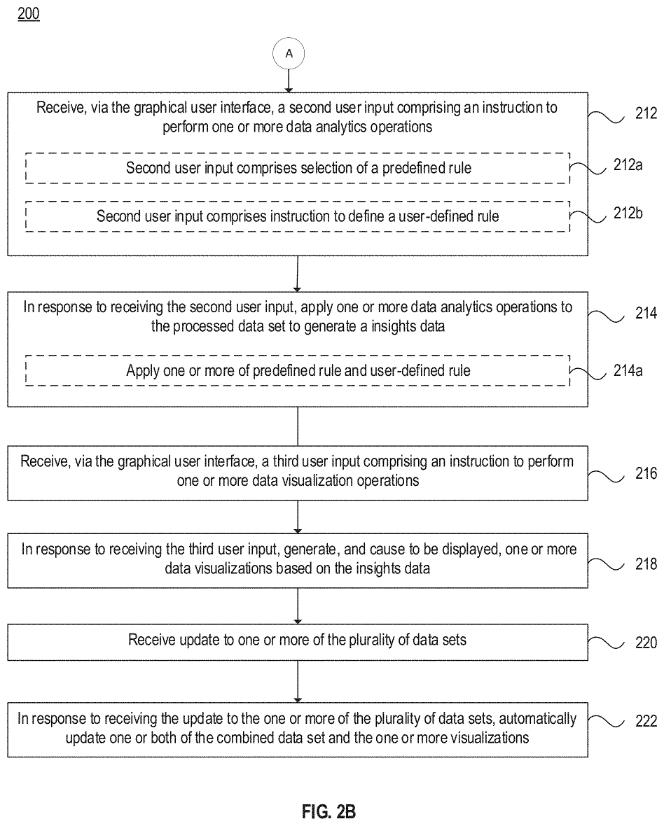

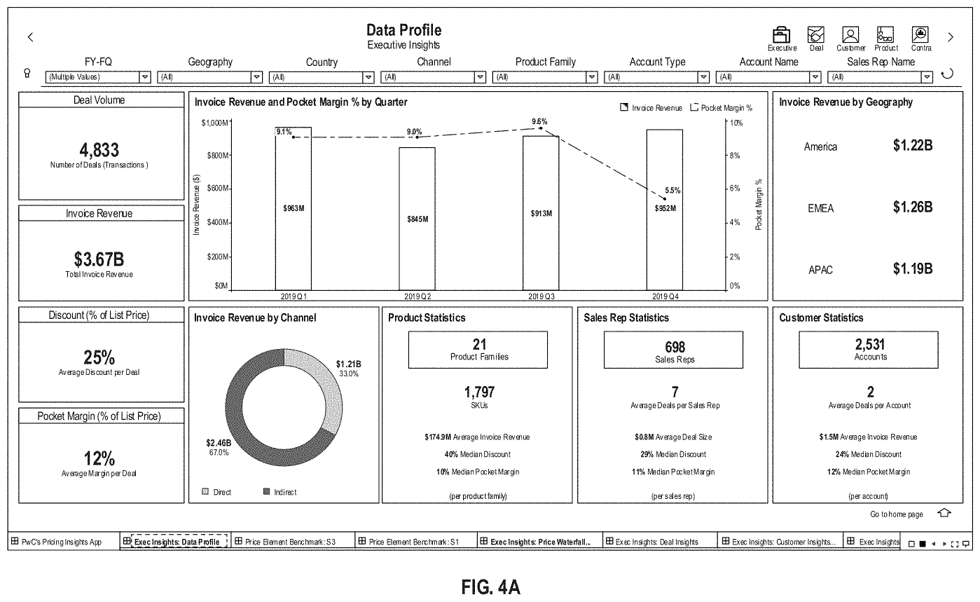

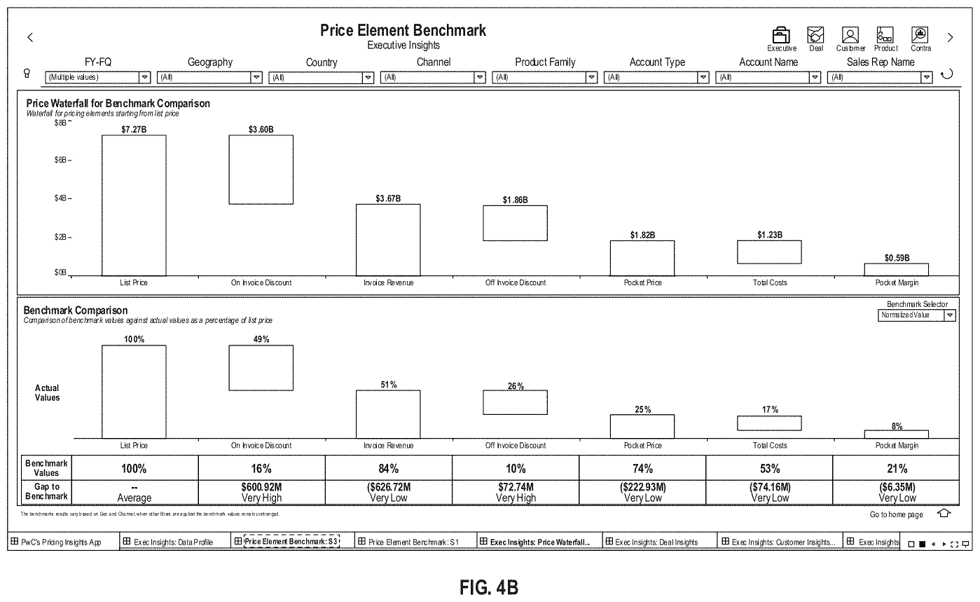

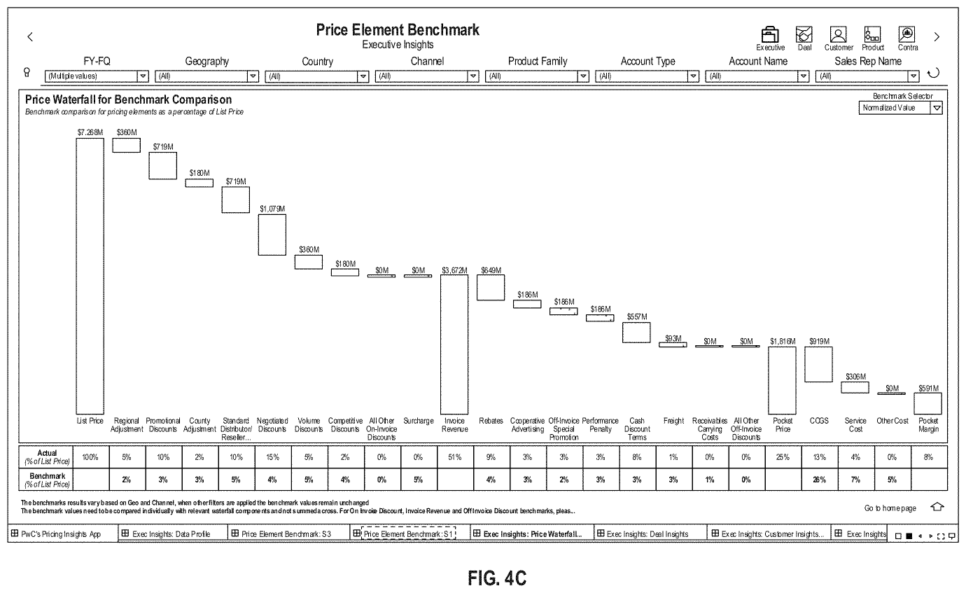

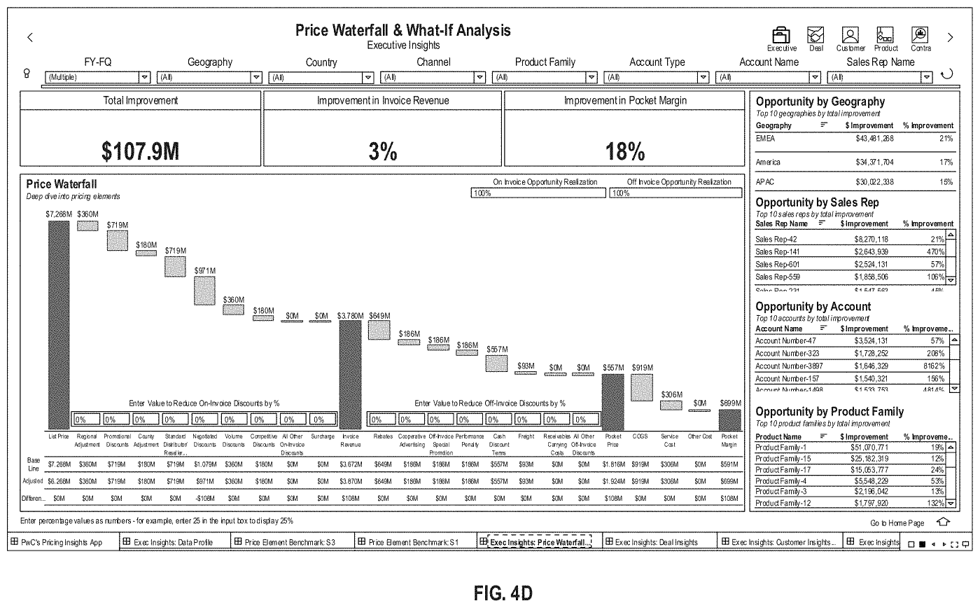

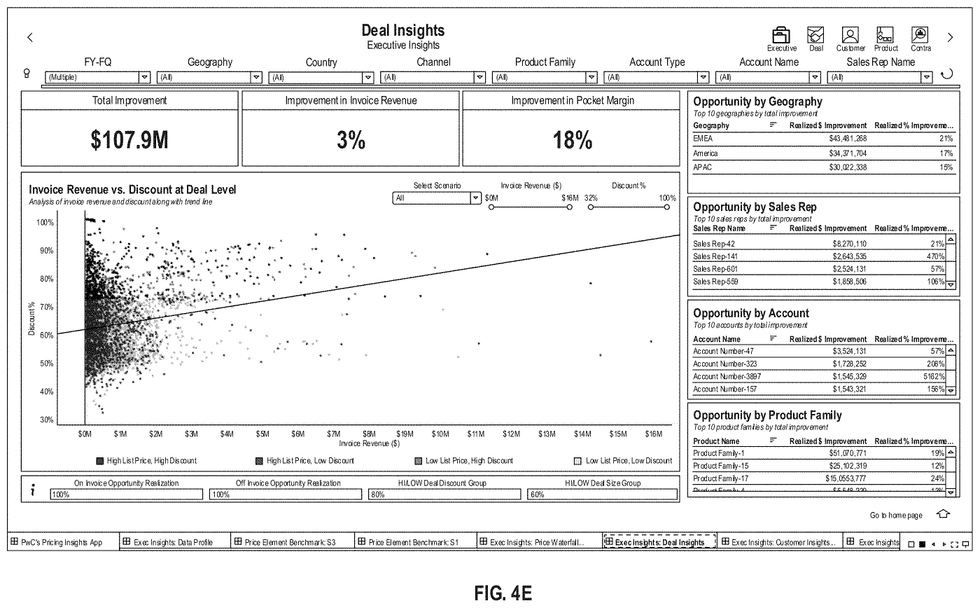

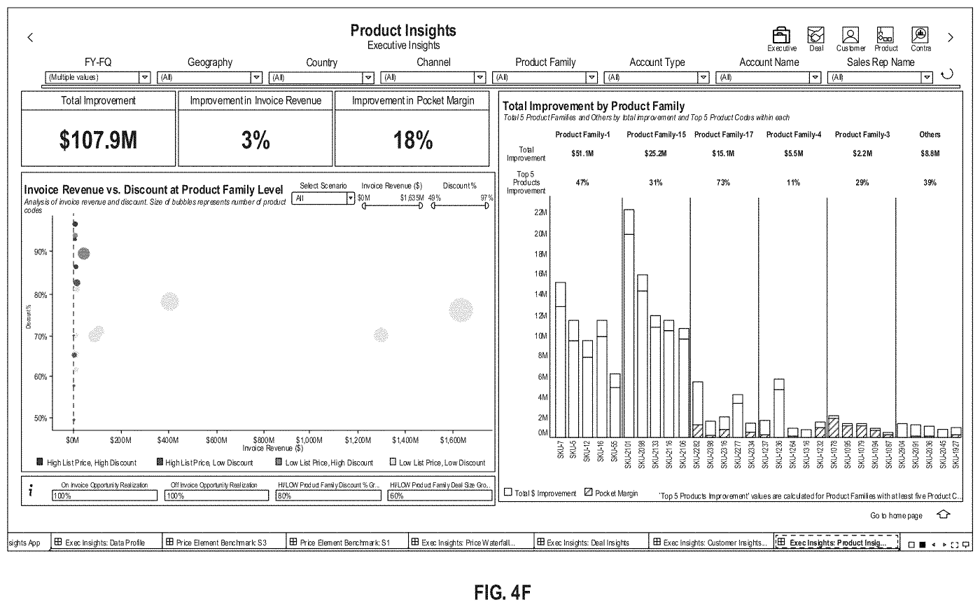

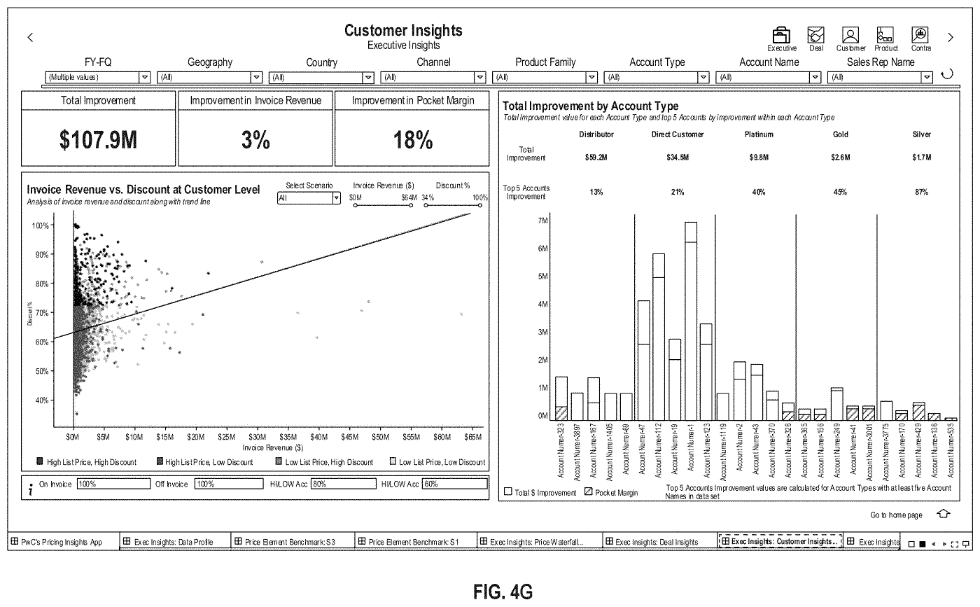

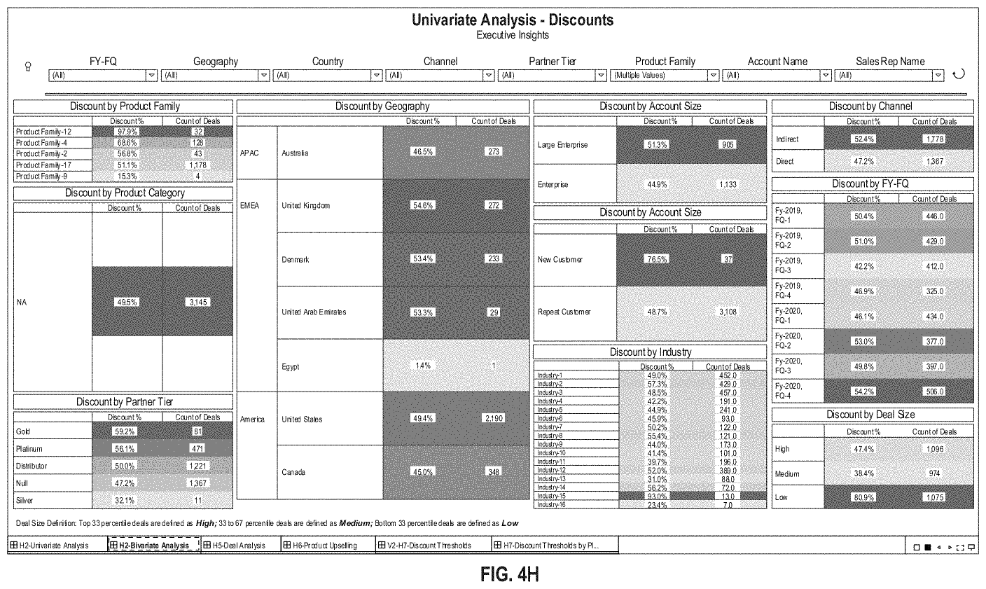

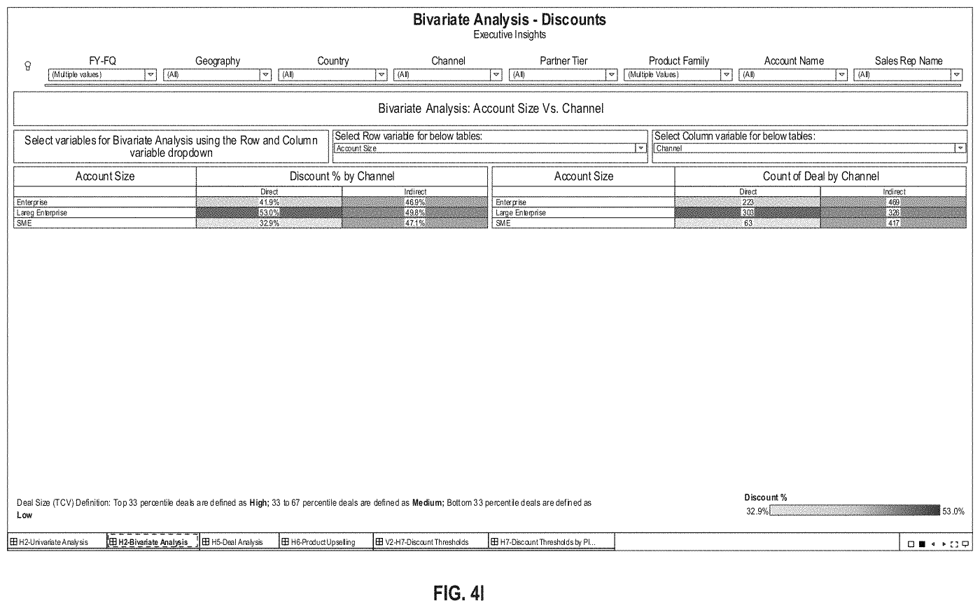

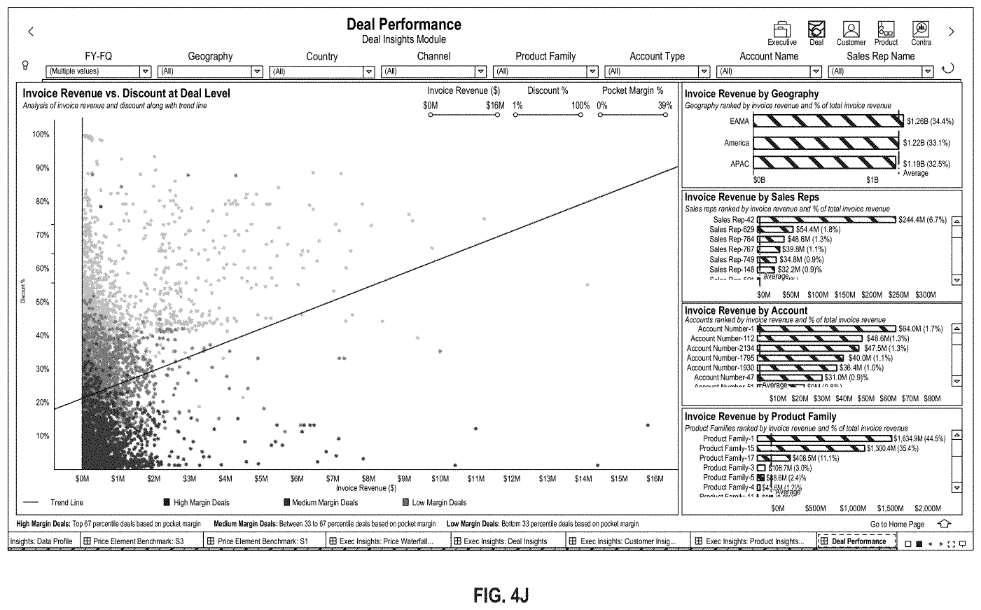

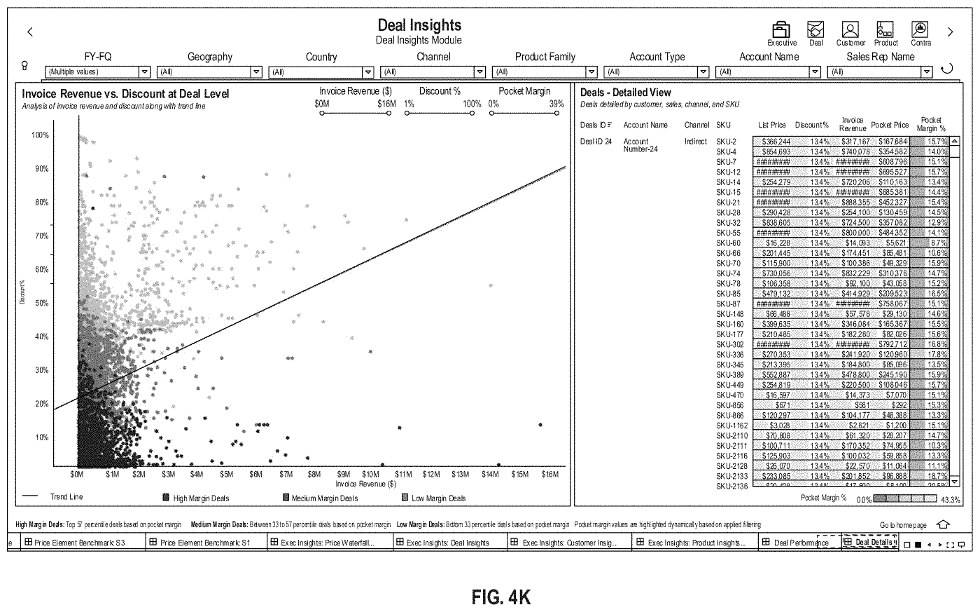

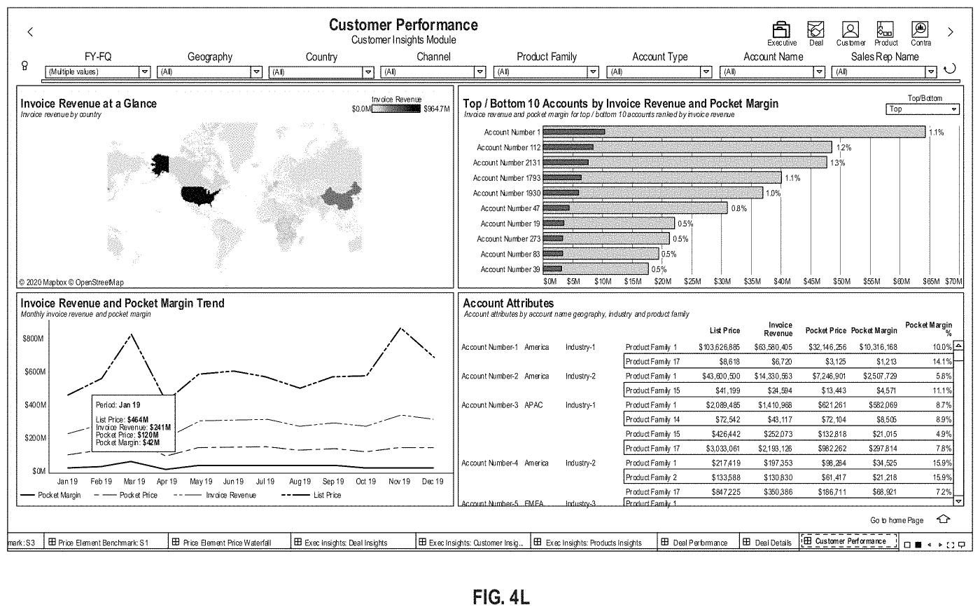

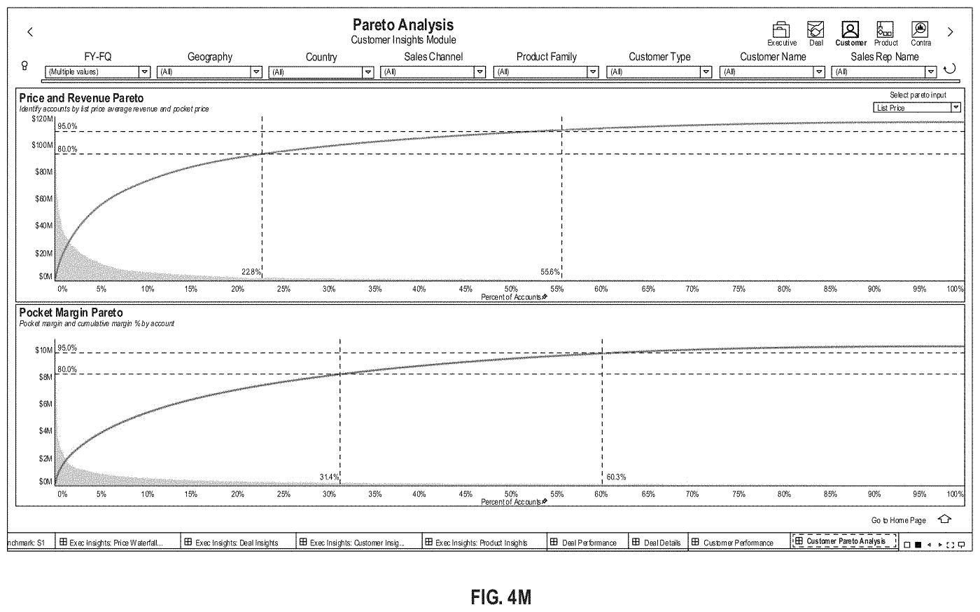

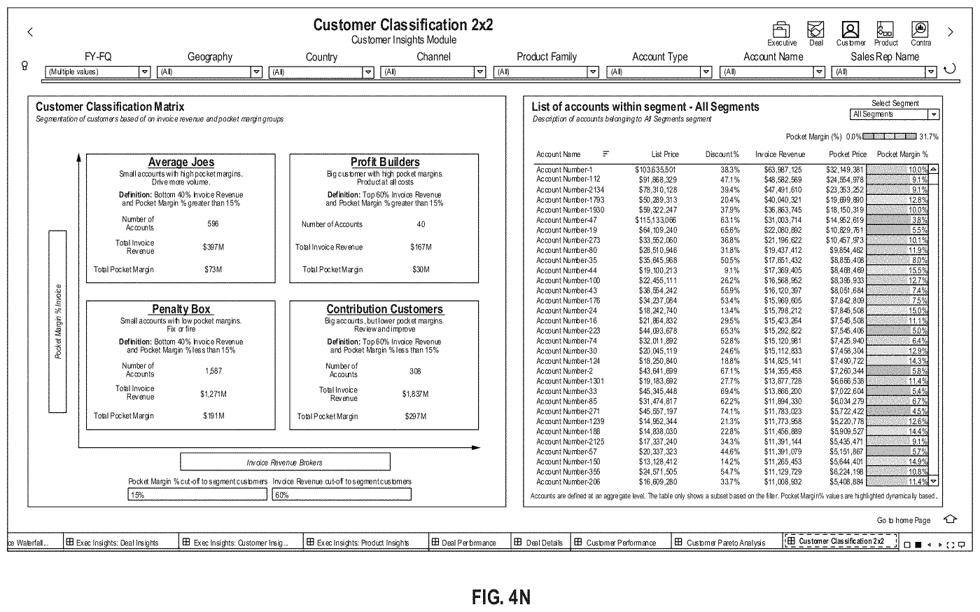

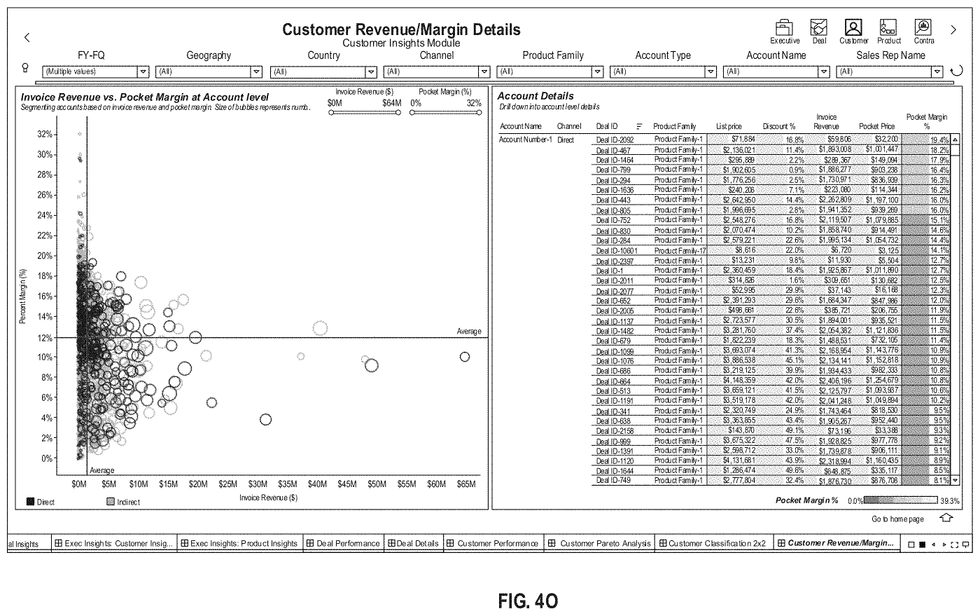

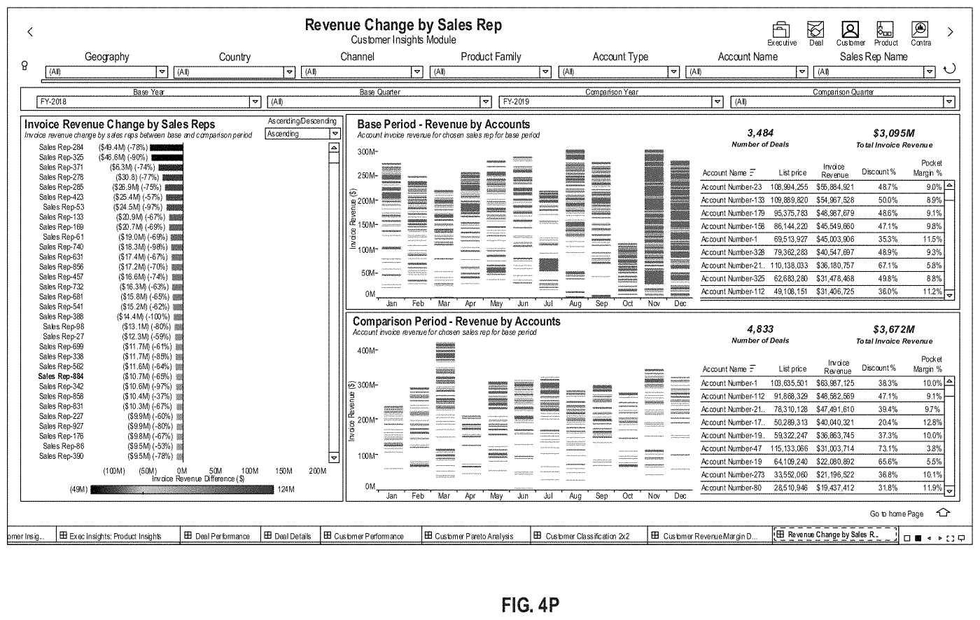

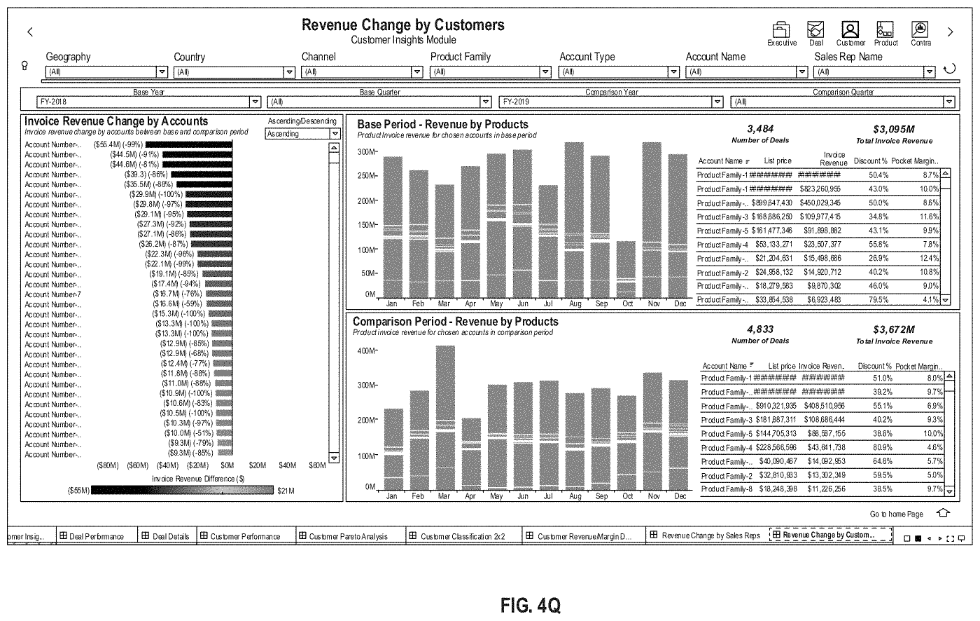

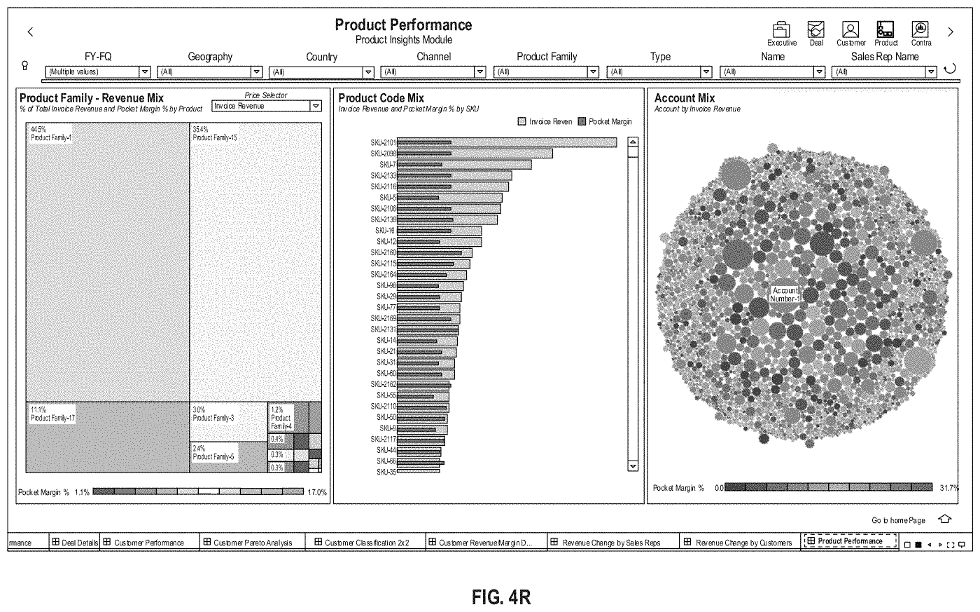

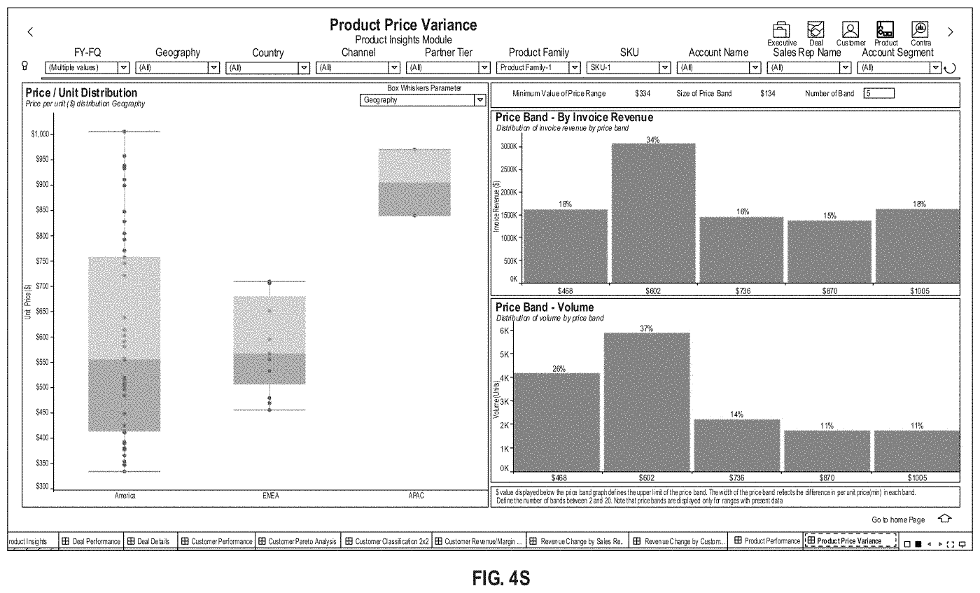

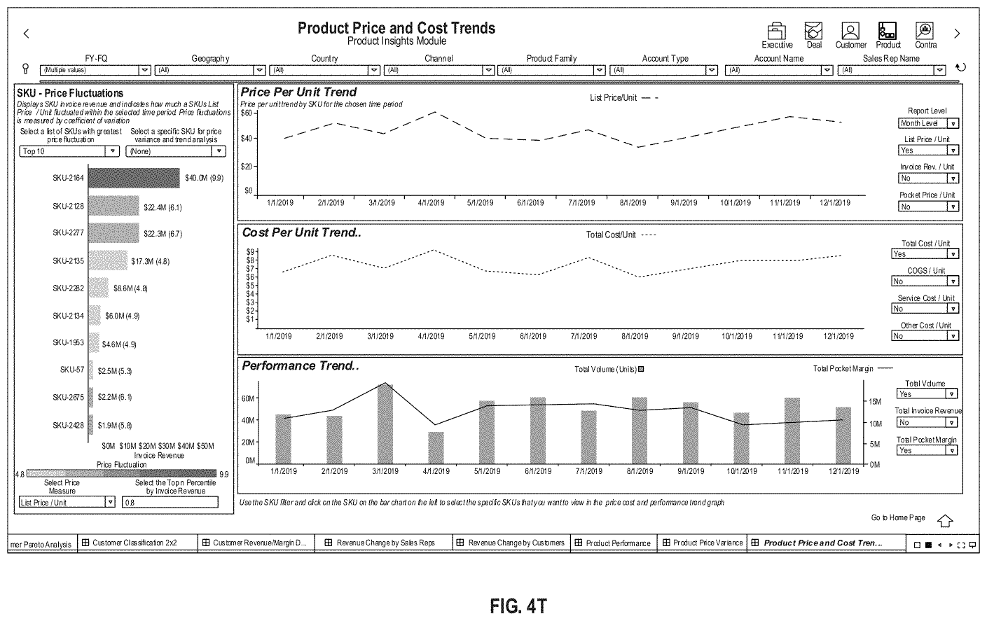

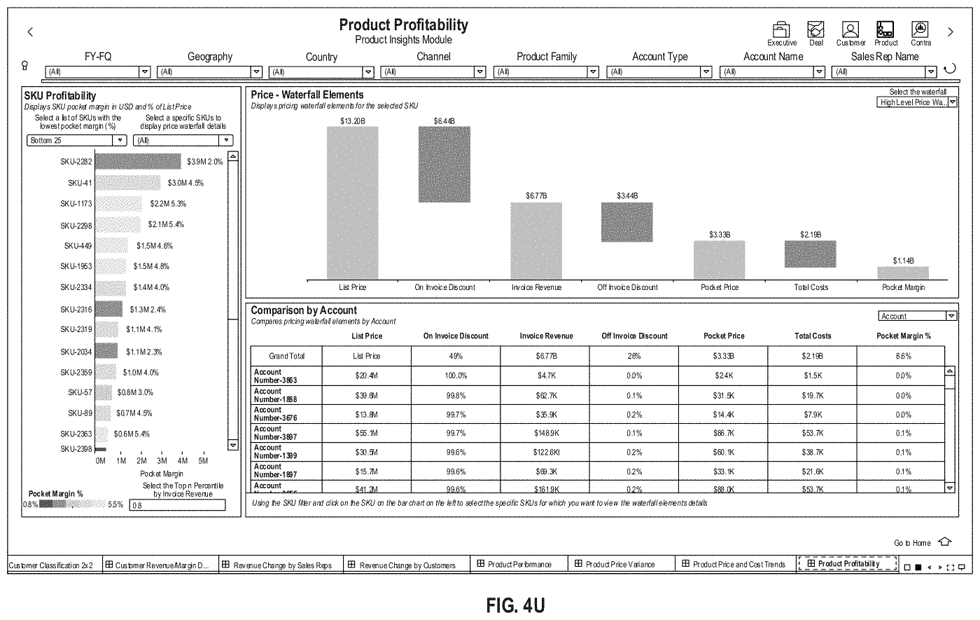

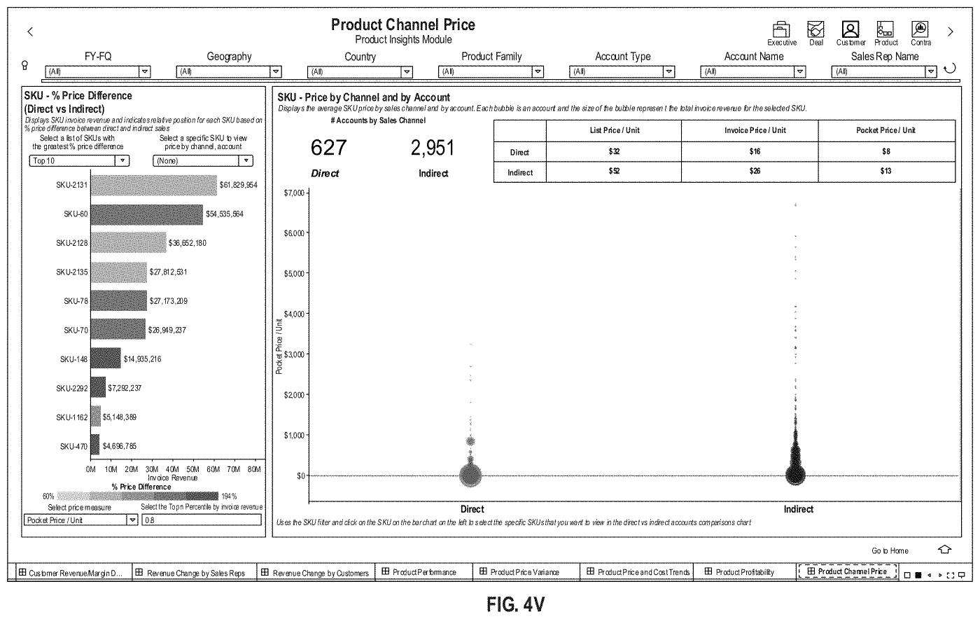

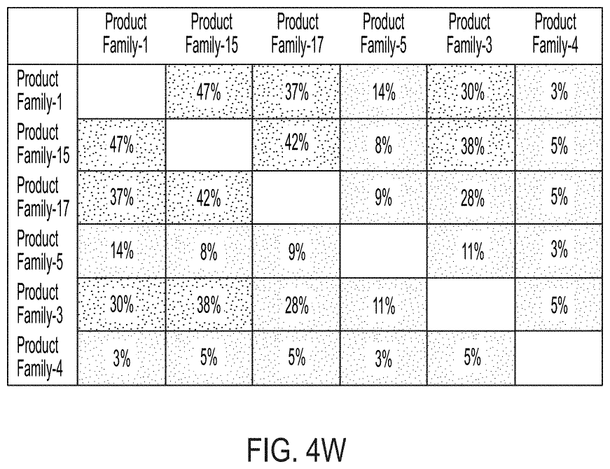

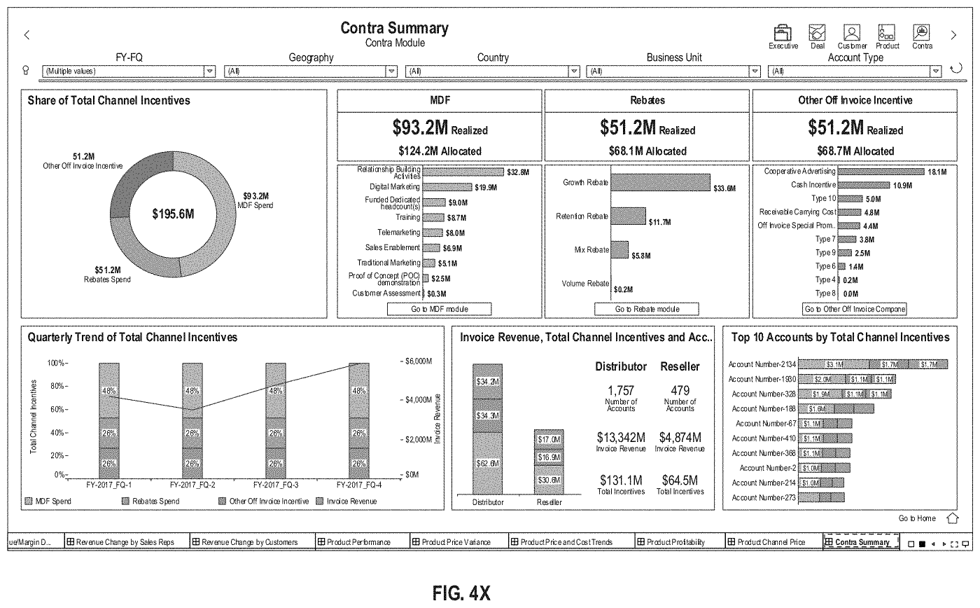

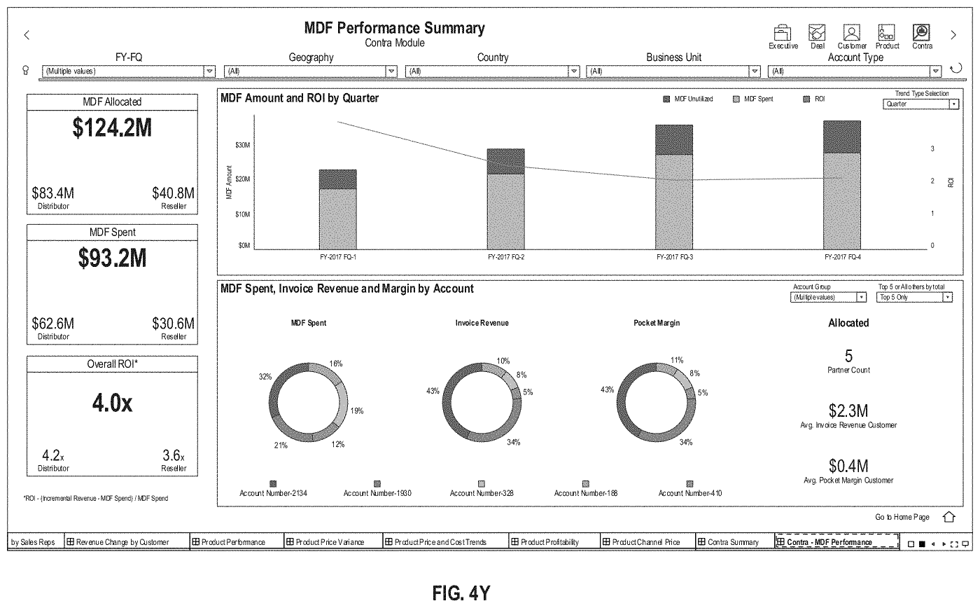

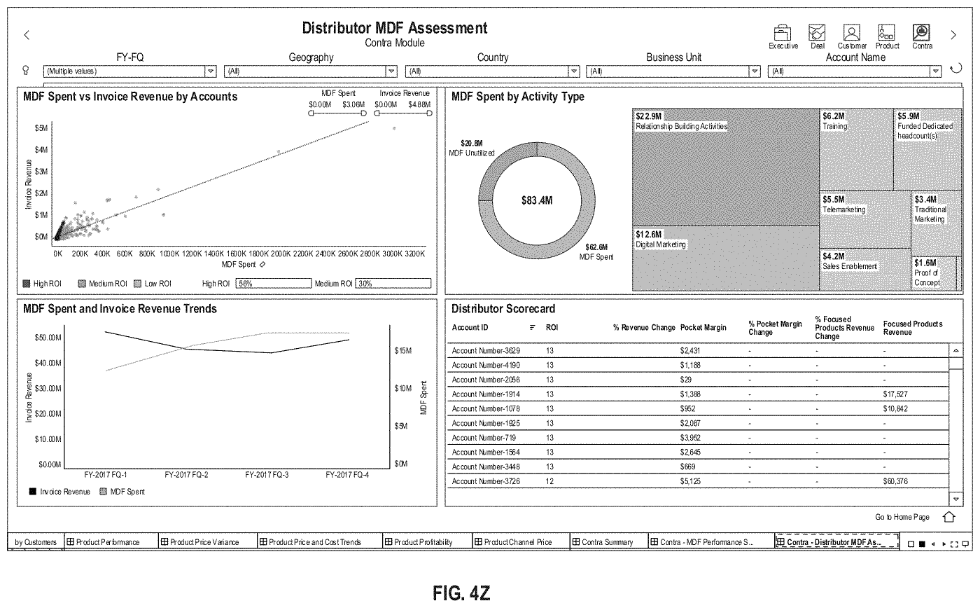

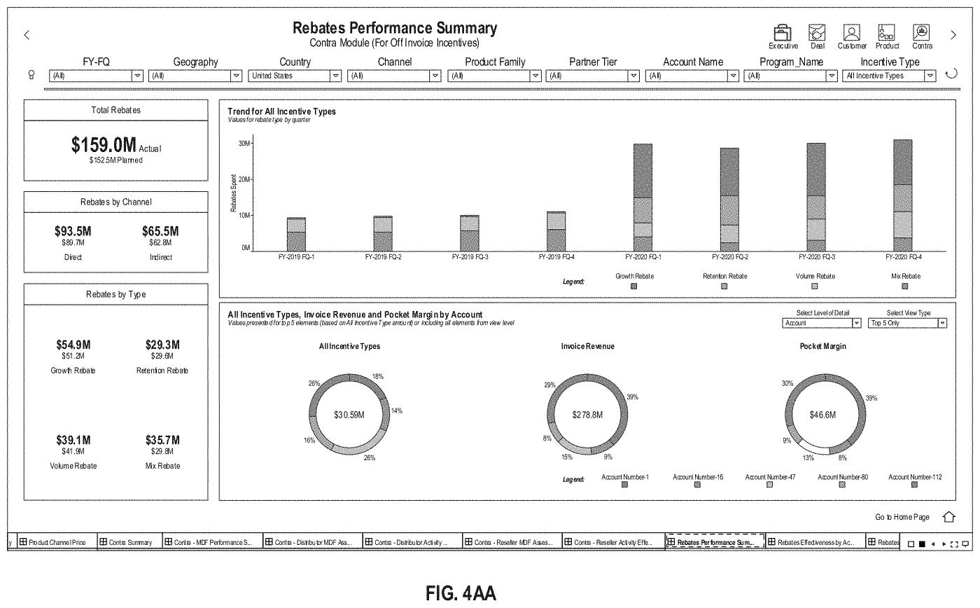

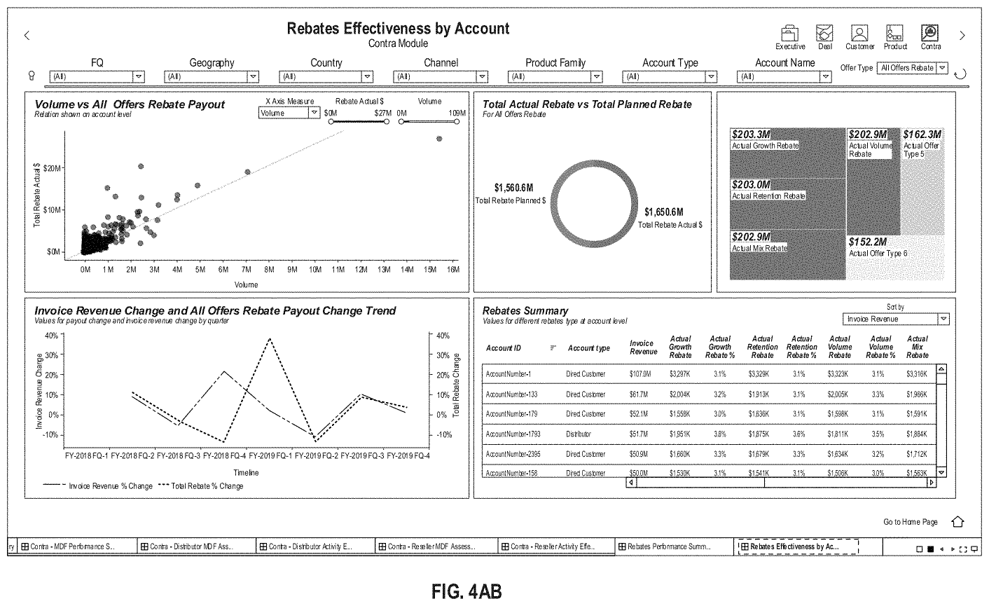

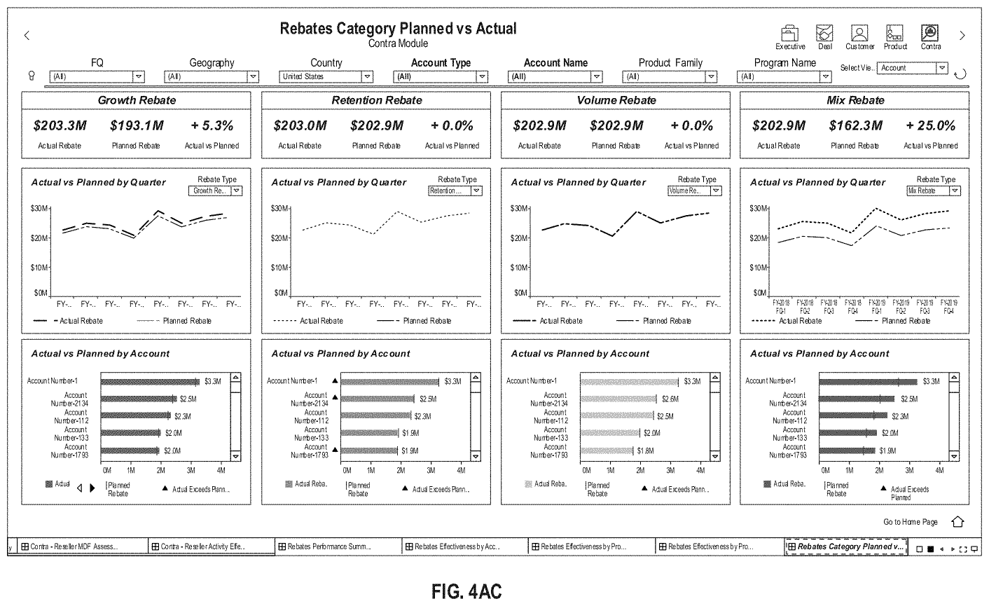

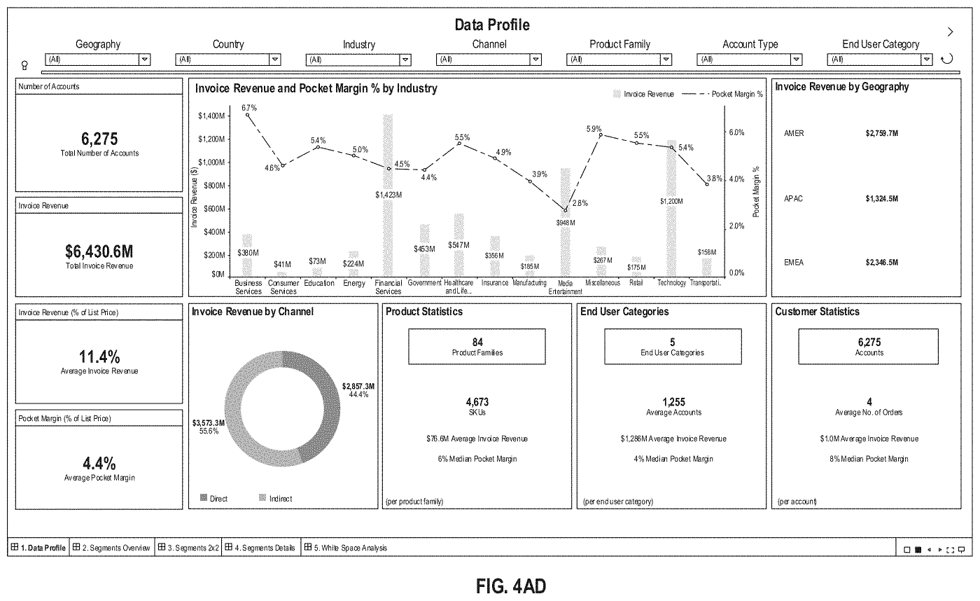

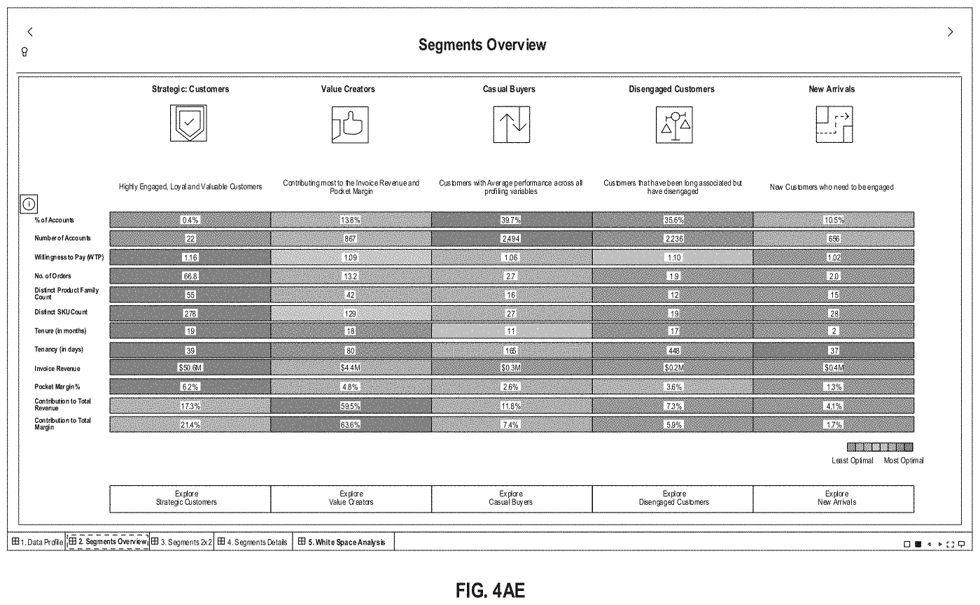

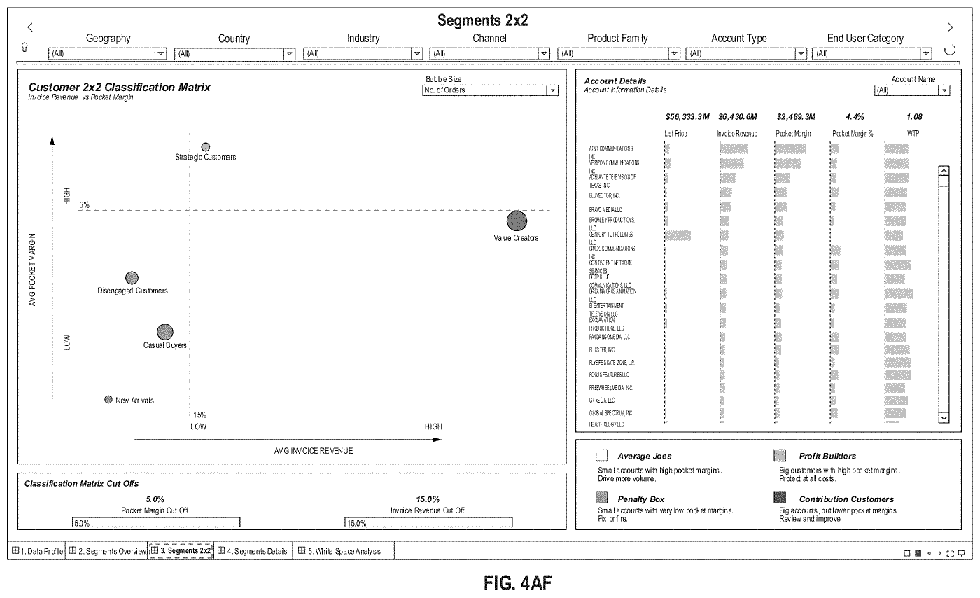

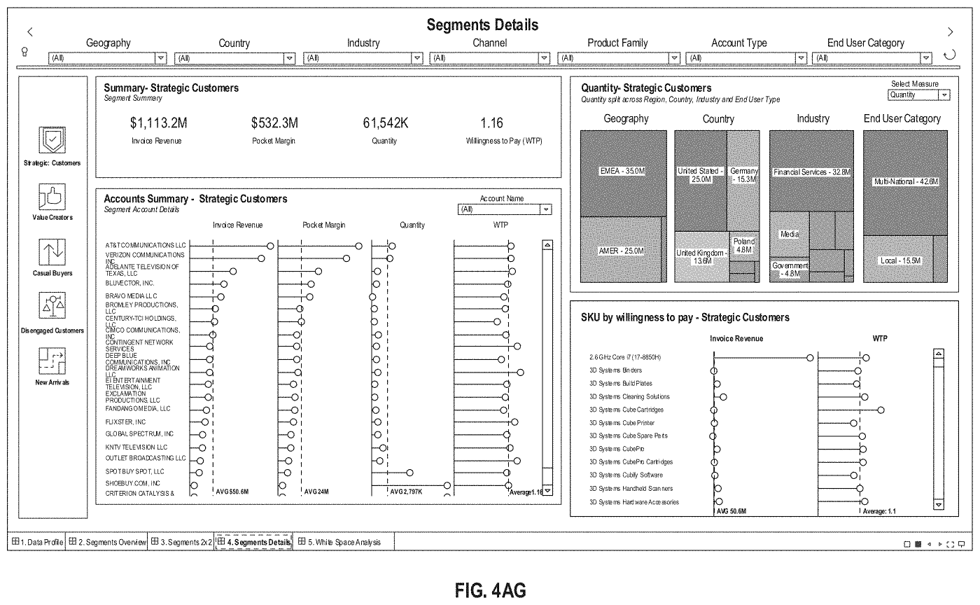

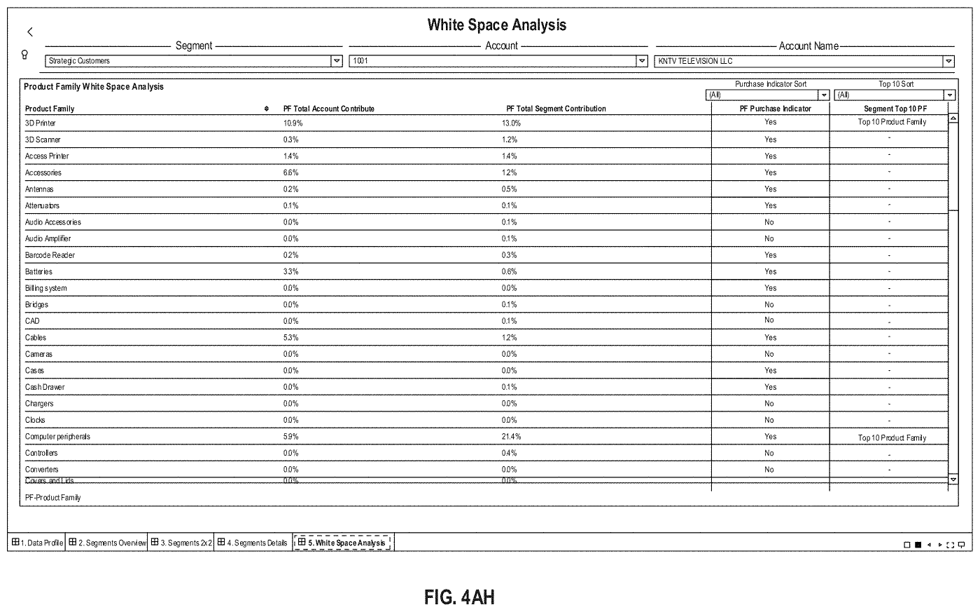

FIGS. 2A-2B depicts a flowchart of a method 200 for using a data set processing and visualization system, according to some embodiments. In some embodiments, method 200 may be performed by a system for data processing and visualization, such as by all or part of system 100 and/or system 104 as described above with respect to FIG. 1. In some embodiments, method 200 includes providing a graphical user interface, which may in some embodiments share any one or more characteristics in common with the graphical user interface described herein with reference to FIG. 4.

At block 202, in some embodiments, the system receives a plurality of data sets from a plurality of respective data sources. In some embodiments, the system may receive one or more data sets via electronic network communication. The data sets may be received by the system in accordance with a manual upload, scraping operation, scheduled upload, programmatically-triggered upload, batch upload, and/or via one or more APIs. In some embodiments, the plurality of data sets may be received from a single data source or may be received from a plurality of distinct data sources. The data sets may be received simultaneously and/or asynchronously. In the example of FIG. 1, the plurality data sets may be received by system 104 from one or more of data sources 102a-102c.

In some embodiments, the system may apply one or more data cleaning operations (a data cleaning operation may be considered a type of “data processing” operation) to all or part of one or more of the received data sets. In some embodiments, data cleaning may comprise applying data cleaning operation in accordance with user inputs executed via one or more data cleaning modules provided by a graphical user interface. All data cleaning operations may be logged when the user makes any changes.

At block 204, in some embodiments, the system cause display of a graphical user interface configured to receive instructions for data merging, data processing, data analytics, and/or data visualization. The term “data processing,” as used herein, may collectively refer to one or more of data merging, data processing, data analytics, and/or data visualization. The graphical user interface may be configured to be displayed to a user (e.g., a salesperson, analyst, manager, or administrator using the system) and may be configured to allow the user to execute inputs to control the manner in which the system applies one or more data processing operations. Thus, a user may use the provided user interface to control the manner in which the system applies one or more data merging, data processing, data analytics, and/or data visualization orations, for example by selecting and/or defining one or more criteria or rule sets in accordance with which the operation(s) is to be applied. In the example of FIG. 1, system 104 may provide instructions to user system 120 such that user system 120 provides graphical user interface 122 to a user. The user may then view displayed information and visualizations and execute one or more inputs via graphical user interface 122 and system 120.

While the disclosure herein may refer to various functionalities that can be accessed by a user, a system may in some embodiments be configured such that certain functionalities are restricted to only be available to certain individual users and/or to users having certain roles. For example, in some embodiments, data processing and/or data merging functionalities may only be accessible to analysts and/or data engineer; while data visualization functionalities may be available to analysts, sales representatives, and/or c-suite users.

At block 206, in some embodiments, the system generates and stores a merged data set by merging the plurality of received data sets. In some embodiments, the system may apply one or more data merging operations to a plurality of received data sets in order to generate one or more merged data sets. A single merged data set may be generated, or a plurality of merged data sets may be generated. One or more merged data sets may include overlapping entities represented in the data. In some embodiments, generating and storing merged data may comprise applying one or more automated scripts to join any number of data sets based on user-defined keys without the user having to edit code. In the example of FIG. 1, data merging engine 106 of system 104 may apply one or more data merging operations to the plurality of received data sets in order to generate and store merged data set 108.

In some embodiments, generating and storing the merged data set may be performed in an automated or semi-automated manner. In some embodiments generating and storing the merged data set may be performed in response to and/or in accordance with one or more user inputs, such as, in the example of FIG. 1, a user input executed via graphical user interface 122 and user system 120.

At block 206a, in some embodiments, generating and storing the merged data set may include applying one or more data cleaning operations to one or more data objects in one or more of the plurality of received data sets. In some embodiments, a data cleaning operation may include applying one or more automated and interactive scripts that allows a user to customize the data cleaning operation.

At block 206b, in some embodiments, generating and storing the merged data set may include applying one or more data aggregation operations to one or more data objects in one or more of the plurality of received data sets. In some embodiments, a data aggregation operation may include applying one or more automated and interactive scripts that allows a user to customize the data aggregation operation.

At block 208, in some embodiments, the system receives, via the graphical user interface, a first user input comprising an instruction to perform one or more data standardization operations. The instruction to perform one or more data standardization operations may include an explicit instruction executed by a user (e.g., clicking a button or icon to execute the operation), and/or may include selection by a user of a visualization, GUI object, or GUI dashboard that automatically triggers execution of the operation. In some embodiments, a user input may indicate an identity of one or more data sets to which the operation is to be applied, a portion of one or more data sets to which the operation is to be applied, a time at which the operation is to be applied, an identity of an algorithm to be applied via the operation, and/or a characteristic of an algorithm to be applied during the operation. In some embodiments, the first user input may be a executed by a data engineer and/or analyst; in some embodiments, the first user input may be executed to generate standardized data that may subsequently be subject to multiple different data processing operations that are instructed by multiple different subsequent inputs (such as multiple different embodiments or iterations of the second user input described below).

At block 208a, in some embodiments, the first user input comprises specification of a characteristic of a data format for a data mapping operation. In some embodiments, data mapping may be applied in order to accelerate a data standardization process. The indicated data format may define a format into which output data generated by the data standardization operation (and/or an included data mapping operation) may be formatted. For example, the user input may provide an indication of a selection of a predefined data format. Alternately or additionally, the user input may define one or more characteristics of a modified or newly-created user-defined data format. Mapping the data may include applying one or more scripts that generate derived fields and/or prepare data for visualization.

At block 210, in some embodiments, the system, in response to receiving the first user input, applies one or more data processing operations to the merged data set to process the merged data set to generate a processed data set. In the example of FIG. 1, data standardization engine 110 of system 104 may apply one or more data standardization operations to merged data set 108 in order to generate and store standardized data set 112.

At block 210a, in some embodiments, applying one or more data processing operations comprises applying a data mapping operation in accordance with the specification of the characteristic of the data format for the data mapping operation (e.g., as described above with reference to block 208a).

At block 210b, in some embodiments, applying one or more data standardization operations comprises generating one or both of wide-form data set and long-form data set. In some embodiments, wide-form data creation may include creating wide-form data with one or more additional columns. In some embodiments, long-form data creation may include creating long-form data with components for an entity (e.g., all price waterfall components for a customer and/or for a deal) in long form. In some embodiments, the wide-form data and long-form data may each be used, alone and/or separately, for one or more visualizations as described herein. In some embodiments, wide-form data may be optimized for creating a first set of one or more visualizations, and long-form data may be optimized for creating a second set of one or more visualizations. In this manner, different processed data sets may be created in which the different processed data sets are configured for optimal use with different sets of visualizations (which may in some embodiments be partially overlapping and in some embodiments may be mutually exclusive).

At block 210c, in some embodiments, applying one or more data standardization operations comprises applying one or more segmentation operations to segment the merged data set, including one or both of a roll-up operation and a join operation. In some embodiments, a segmentation operation may categorize customers in different segments such as strategically important customers, new customers, potentially valuable customers, old customers, and/or disengaged customers, based on multiple attributes of each customer such as previous buying behavior. A segmentation operation applied by the system may enable users to examine segmented customer data to gain insights regarding customer behaviors, to compare poor performing customers to high performing customers, and/or to identify short-term and long-term opportunities based on segments.

A segmentation operation applied by the system may be a flexible data model that allows users to change or modify (e.g., weight) one or more attributes that are used for segmentation and select final profiling variables, e.g. to select variables customized for different industries. In some embodiments, applying a segmentation operation may comprise determining a quantification or characterization of a customer's willingness to pay (WTP). A WTP metric may be determined for a customer generally, or it may be determined for a customer with respect to a specific product. A WTP metric may be used to group customers into segments according to WTP.

At block 212, in some embodiments, the system receives, via the graphical user interface, a second user input comprising an instruction to perform one or more data analytics operations. The instruction to perform one or more data analytics operations may include an explicit instruction executed by a user (e.g., clicking a button or icon to execute the operation), and/or may include selection by a user of a visualization, GUI object, or GUI dashboard that automatically triggers execution of the operation. In some embodiments, a user input may indicate an identity of one or more data sets to which the operation is to be applied, a portion of one or more data sets to which the operation is to be applied, a time at which the operation is to be applied, an identity of an algorithm to be applied via the operation, and/or a characteristic of an algorithm to be applied during the operation. In some embodiments, the second user input may be a executed by a different user or a different role than the first user input; for example, while the first user input may have been executed by a data engineer and/or analyst, the second user input may be executed by a sales representative, analyst, and/or c-suite user.

At block 212a, in some embodiments, the second user input comprises selection of a predefined rule. At block 212b, in some embodiments, the second user input comprises instruction to define a user-defined rule. A predefined and/or user-defined rule for a data analytics operation may define a manner in which the data analytics operation is applied, such as by defining or characterizing one or more algorithms, filters, thresholds, parameters, (e.g., visualization parameters), or the like.

At block 214, in some embodiments, in response to receiving the second user input, the system applies one or more data analytics operations to the processed data set to generate insights data. In the example of FIG. 1, data analytics engine 114 of system 104 may apply one or more data analytics operations to standardized data set 112 in order to generate and store insights data 116. In some embodiments, insights data 116 may be any dataset (e.g., an analytical dataset and/or visualization dataset) that may be characterize, quantify, visualize, analyze, or address one or more aspects of business knowledge, for example by providing data summaries, data correlations, and/or data visualizations. For example, insights data 116 may allow users to glean insights by demonstrating data anomalies from trends, clusters, or averages, for example by showing if a particular product being given high discounts compared to other products.

At block 214a, in some embodiments, applying one or more data analytics operations comprises applying one or more of a predefined rule and a user-defined rule (e.g., as described above with reference to block 212a).

At block 216, in some embodiments, the system receives, via the graphical user interface, a third user input comprising an instruction to perform one or more data visualization operations. The instruction to perform one or more data visualization operations may include an explicit instruction executed by a user (e.g., clicking a button or icon to execute the operation), and/or may include selection by a user of a visualization, GUI object, or GUI dashboard that automatically triggers execution of the operation. In some embodiments, a user input may indicate an identity of one or more data sets to which the operation is to be applied, a portion of one or more data sets to which the operation is to be applied, a time at which the operation is to be applied, an identity of an algorithm to be applied via the operation, and/or a characteristic of an algorithm to be applied during the operation.

At block 218, in some embodiments, the system, in response to receiving the third user input, generates, and causes to be displayed, one or more data visualizations based on the insights data. In the example of FIG. 1, data visualization engine 118 of system 104 may apply one or more data visualization operations to insights data 116 in order to generate one or more data visualizations that may be provided to user system 120 for display via graphical user interface 122. Additionally or alternatively, the one or more data visualizations may be stored (e.g., for future retrieval and/or display) in one or more computer storage systems included in or associated with system 104 and/or user system 120.

At block 220, in some embodiments, the system receives an update to one or more of the plurality of data sets. In some embodiments, the system may receive updated data sets and/or additional data sets in a same or similar manner, including from the same, similar, or different/additional data sources, as the system received one or more of the plurality of data sets as described above with reference to block 202.

At block 222, in some embodiments, the system, in response to receiving the update to the one or more of the plurality of data sets, automatically updates one or both of the merged data set and the one or more visualizations. In some embodiments, receipt of additional data sets and/or updated data sets may automatically trigger one or more data processing operations, applied to the newly received data, by the system. In some embodiments, the one or more data processing operations applied to the newly received data may be applied in response to and/or in accordance with one or more user inputs. In some embodiments, the system may apply anyone or more of a data merging operation, a data standardization operation, a data analytics operation, and/or a data visualization operation, application of any one or more of which may share one or more characteristics in common with the application of said operations to the originally-received data sets described above with respect to method 200. In this manner, data stored by the system and/or visualizations provided by the system may be automatically updated as new data is received.

While FIG. 2 shows the various data processing operations being applied in an exemplary order, a person of ordinary skill in the art will understand, in light of the disclosure herein, that one or more of the data processing operations may be performed alone and/or in combination with one or more of the other operations in any suitable order.

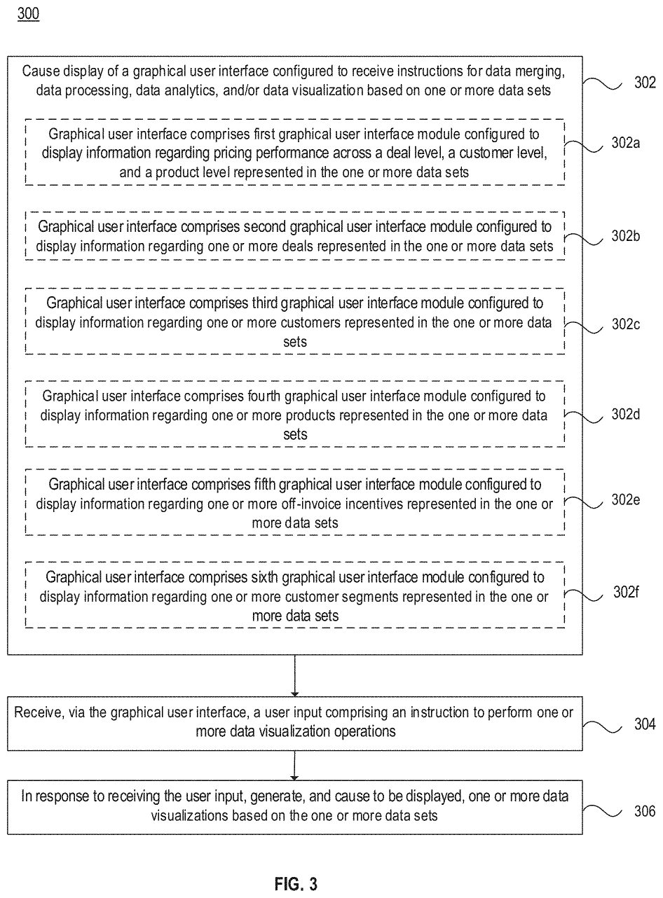

FIG. 3 depicts a flowchart of a method 300 for using a data set processing and visualization system, according to some embodiments. In some embodiments, method 300 may be performed by a system for data processing and visualization, such as by all or part of system 100 and/or system 104 as described above with respect to FIG. 1. In some embodiments, method 300 includes providing a graphical user interface, which may in some embodiments share any one or more characteristics in common with the graphical user interface described herein with reference to FIGS. 4A-4AH.

At block 302, in some embodiments, the system causes display of a graphical user interface configured to receive instructions for data merging, data processing, data analytics, and/or data visualization based on one or more data sets. The graphical user interface may be configured to receive instructions for data processing, and may be configured to be displayed to a user (e.g., a salesperson, analyst, manager, or administrator using the system) to allow the user to execute inputs to control the manner in which the system applies one or more data processing operations. In some embodiments, the graphical user interface may share any one or more characteristics in common with graphical user interfaces described elsewhere herein, including graphical user interface 122 described with respect to FIG. 1, the graphical user interface(s) described with respect to method 200 and FIG. 2, and/or the graphical user interface described with respect to FIGS. 4A-4AH. In the example of FIG. 1, system 104 may provide instructions to user system 120 such that user system 120 provides graphical user interface 122 to a user. The user may then view displayed information and visualizations and execute one or more inputs via graphical user interface 122 and system 120.

At block 302a, in some embodiments, the graphical user interface comprises a first graphical user interface module configured to display information regarding pricing performance across a deal level, a customer level, and a product level represented in the one or more data sets. In some embodiments, the first module may be an “Executive module” of a graphical user interface for providing pricing information and visualizations to analysts, salespersons, managers, and/or administrators within business organization. In some embodiments, the first module may share any one or more characteristics in common with the executive module described below with reference to FIGS. 4A-4I.

At block 302b, in some embodiments, the graphical user interface comprises a second graphical user interface module configured to display information regarding one or more deals represented in the one or more data sets. In some embodiments, the second module may be a “Deal module” of a graphical user interface for providing pricing information and visualizations to analysts, salespersons, managers, and/or administrators within business organization. In some embodiments, the second module may share any one or more characteristics in common with the deal module described below with reference to FIGS. 4J-4K.

At block 302c, in some embodiments, the graphical user interface comprises a third graphical user interface module configured to display information regarding one or more customers represented in the one or more data sets. In some embodiments, the third module may be a “Customer module” of a graphical user interface for providing pricing information and visualizations to analysts, salespersons, managers, and/or administrators within business organization. In some embodiments, the third module may share any one or more characteristics in common with the customer module described below with reference to FIGS. 4L-4Q.

At block 302d, in some embodiments, the graphical user interface comprises a fourth graphical user interface module configured to display information regarding one or more products represented in the one or more data sets. In some embodiments, the fourth module may be a “Product module” of a graphical user interface for providing pricing information and visualizations to analysts, salespersons, managers, and/or administrators within business organization. In some embodiments, the fourth module may share any one or more characteristics in common with the product module described below with reference to FIGS. 4R-4W.

At block 302e, in some embodiments, the graphical user interface comprises a fifth graphical user interface module configured to display information regarding one or more off-invoice incentives represented in the one or more data sets. In some embodiments, the fifth module may be a “Contra module” of a graphical user interface for providing pricing information and visualizations to analysts, salespersons, managers, and/or administrators within business organization. In some embodiments, the fifth module may share any one or more characteristics in common with the contra module described below with reference to FIGS. 4X-4AC.

At block 302f, in some embodiments, the graphical user interface comprises a sixth graphical user interface module configured to display information regarding one or more customer segments represented in the one or more data sets. In some embodiments, the sixth module may be a “Segmentation module” of a graphical user interface for providing pricing information and visualizations to analysts, salespersons, managers, and/or administrators within business organization. In some embodiments, the sixth module may share any one or more characteristics in common with the segmentation module described below with reference to FIGS. 4AD-4AH.

At block 304, in some embodiments, the system receives, via the graphical user interface, a user input comprising an instruction to perform one or more data visualization operations. In some embodiments, the user input may share any one or more characteristics in common with any one or more of the user inputs described above with respect to method 200 in FIG. 2.

At block 306, in some embodiments, the system, in response to receiving the user input, generates, and causes to be displayed, one or more data visualizations based on the one or more data sets. In some embodiments, the one or more data visualizations may share any one or more characteristics in common with any one or more visualizations described elsewhere herein, including but not limited to any of the data visualizations shown in and/or described with reference to FIGS. 4A-4AH below.

FIGS. 4A-4AH show various dashboards of a multi-module graphical user interface 400 provided by a graphical user interface for data set processing and visualization, according to some embodiments. In some embodiments, graphical user interface 400 share any one or more characteristics in common with graphical user interface 122 described above with reference to FIG. 1. In some embodiments, graphical user interface 400 may be provided as part of method 200 (described above with respect to FIG. 2) and/or method 300 (described above with respect to FIG. 3).

As described below, multi-module graphical user interface 400 may enables non-technical users of the interface to control data processing and data visualization parameters and to generate visualizations of complex computations related to the data ingested by the system. Users of the interface may thus be able to quickly and easily access information regarding, for example: price waterfall and price realization, deal discounting, customer segmentation, product mix analysis, and/or channel rebates.

In some embodiments, the modules described below of graphical user interface 400 may visualize some or all of the data that has been ingested and/or processed by the system (e.g., the data ingested by system 100). Users may use the modules to execute inputs via graphical user interface 400 to control the manner in which data is ingested, processed, and/or visualized. In some embodiments, different modules may leverage different subsets of ingested data. For example, in some embodiments, an executive model, product module, customer module, and/or deals module may leverage transaction data and benchmarks data for the sector/industry if said benchmark data is available. In some embodiments, a segmentation module may leverage transaction data and one or more additional data models, for example as described further below. In some embodiments, a contra module (including rebates dashboards of said contra module) may leverage transaction data, benchmark data, lead and effectiveness periods data, MDF data, planned rebates program data, and/or actual rebates data; a contra module may use said data to build data models for mapping and calculation of derivative data.

FIGS. 4A-4I depict dashboards of an executive module of graphical user interface 400. In some embodiments, the executive module may enable users to identify opportunity assessment through pricing price waterfall analyses and what-if analyses. In some embodiments, an executive module may include one or more dashboards (e.g., dashboards) configured to provide data profile information and visualizations, price waterfall information and visualizations, benchmark information and visualizations, and executive insights information and visualizations. Information and visualizations may be provided for one or more deals, one or more customers, and/or one or more products. An executive module may provide a high level overview of pricing performance across various levels (e.g., deal level, customer level, product level), and may allow users to identify opportunities for improvement in price realization and margin leakage reduction. In some embodiments, graphical user interface 400 may be configured such that only users with certain permissions are able to access the executive module; for example, a system may be configured such that only executives, administrators, and/or managers can access the executive module.

FIG. 4A depicts a data profile dashboard of graphical user interface 400 that may be displayed as part of an executive module of graphical user interface 400. The data profile dashboard may provide summary information for the underlying data, wherein the summary information may be organized by region, time period, product, family, channel, customer, and/or sales representative. The data profile dashboard may identify sudden changes in margin or sales in a time period for the available data. This features may enables users to pinpoint revenue and margin improvement areas across major attributes of a transaction in a business-to-business environment

FIG. 4B depicts a price element benchmark price waterfall dashboard of graphical user interface 400 that may be displayed as part of an executive module of graphical user interface 400. FIG. 4C depicts a price element benchmark price waterfall dashboard of graphical user interface 400 that may be displayed as part of an executive module of graphical user interface 400.

The price element benchmark price waterfall dashboards may be based on benchmark data that compares a specific company's data against data for an industry or sector, which may be based on survey data.

In some embodiments, data used to generate benchmarking comparisons (e.g., third-party data such as survey data) may be organized across various geographies, various sub-industries, various entity size classifications (e.g., <$1B, $1B-$5B, and $5B+), various sales channels (e.g., direct/indirect), and/or and various types of price management solutions (e.g., CPQ, enterprise, home-grown, spreadsheets).

In some embodiments, benchmarking comparisons and visualizations for price waterfall elements may include, for example: (i) list price; (ii) on-invoice discounts, such as country adjustment, regional adjustment, standard channel discount, competitive discount, volume discount, negotiated discount, promotional discount, and/or surcharge; (iii) off-invoice incentives, such as rebate, market development fund (MDF), cooperative advertising, cooperative advertising, off-invoice special promotion, performance penalty, cash discount terms, receivables carrying cost, and/or freight; (iv) total costs, such as COGS and/or service cost; and/or pocket margins. These benchmark comparisons may be leveraged to identify opportunities for improvement when, for example, there is wide variation in discounting levels and incentive programs leading to margin erosion.

In some embodiments, benchmarking comparisons for MDF spend in channel may provide, for example, MDF allocation insights, policy insights, system insights, and/or challenges and improvement insights. These benchmarks may be leveraged to understand the structure and effectiveness of partner incentives and MDF.

FIG. 4D depicts a price waterfall and what-if analysis dashboard of graphical user interface 400 that may be displayed as part of an executive module of graphical user interface 400. Graphical user interface 400 may provide price waterfall transparency and enable scenario analysis, which may be achieved through interactive cross-dashboard filters and actions that reveal revenue and margin opportunities for a company. The price waterfall and what-if analysis dashboard may enable users to simulate various scenarios in accordance with user inputs. For example, the user can specify discount reductions to different price waterfall elements and view those reductions' effectiveness on improvement in invoice revenue and/or pocket margin. This can be further used to assess opportunities by region, sales representative, account, and/or product family. The resulting data can be compared against industry benchmarks and gaps can be clearly identified. Further, this simulation can be drilled down to deal level, customer level, and/or product level in the depicted price waterfall and what-if analysis dashboard and/or on another price waterfall and what-if analysis dashboard.

FIG. 4E depicts a deal insights dashboard of graphical user interface 400 that may be displayed as part of an executive module of graphical user interface 400. FIG. 4F depicts a product insights dashboard of graphical user interface 400 that may be displayed as part of an executive module of graphical user interface 400. FIG. 4G depicts a customer insights dashboard of graphical user interface 400 that may be displayed as part of an executive module of graphical user interface 400.

This set of dashboards shown in FIGS. 4E-4G may allow for flow of values from a price waterfall (e.g., a price waterfall visualization displayed on another dashboard in the executive module) and pass through realization parameters to generate one or more visualizations of one or more effects on deals, customers, and/or products. Realization parameters are an empirical method to estimate what percent of on-invoice and/or off-invoice incentives will be impactful on improvement figures. An ideal scenario may be 100% realization, according to which all discounts translate to improvements.

This set of dashboards shown in FIGS. 4E-4G may provide a fine level of improvement details. For example, the product insights dashboard includes a visualization that shows top product families that gain improvements from a price waterfall discount and also shows SKUs within those top product families that are the highest improvement gainers therein. This may allow a business to specifically focus on SKUs from a price waterfall discount, which may enable the business to develop actionable insights.

The deal insights dashboard and customer insights dashboard may enable users to visualize potential revenue improvement opportunities when discounts are reduced for customers who are classified into a high priority classification. These opportunities may be aggregated by customer type (e.g., “high priority”) to highlight areas of greatest opportunity.

One or more of the dashboards shown in FIGS. 4E-4G may also provide flexibility to change HI/LOW thresholds for discount and size of deals measured by invoice revenue.

FIG. 4H depicts a univariate discount analysis dashboard of graphical user interface 400 that may be displayed as part of an executive module of graphical user interface 400. FIG. 4I depicts a bivariate discount analysis dashboard of graphical user interface 400 that may be displayed as part of an executive module of graphical user interface 400.

The dashboards shown in FIGS. 4H and 4I may provide visualization of information regarding variation of discounts by various categorical attributes across customers, products, and/or deals.

The univariate discounts analysis dashboard may help users to identify specific attributes that drive high discounts. The displayed count of transactions may help validate the impact of variation. The bivariate discounts analysis may help users identify interdependencies between attributes to provide insight into discount variance. The two dashboards together may help users discover attributes that cause higher discounts levels for a company.

FIGS. 4J-4K depict dashboards of a deal module of graphical user interface 400. In some embodiments, a deal module may enable users to track deal anomalies by identifying low-margins deals and/or high-discount deals. A deal module may enable users to identify strategic accounts and view account-level guidance for product mix, SKUs, and/or upselling. A Deals module may enable users to apply a deal performance analysis for discounts offered versus the invoice revenue generated, and may enable users to view top performers for different types of splits.

FIG. 4J depicts a deal performance dashboard of graphical user interface 400 that may be displayed as part of a deal module of graphical user interface 400. A deal performance dashboard may include an indication of a deal categorization based on one or both of revenue for the deal and a discount for the deal. In some embodiments, a user input executed via the dashboard may define a parameter and/or threshold for categorizing deals, e.g., for categorizing deals based on revenue and/or discount. A deal performance dashboard may include an indication of a deal categorization based on one or both of a discount percentile and a slider filter functionality to vary discounts. A deal performance dashboard may enable users to identify attributes of underperforming deals by region, sales representative, account, product, family, etc. A deal performance dashboard may include a scatterplot visualization of deals that provides a user the ability to filter deals by invoice revenue, discount percent, and/or margin. Shortlisted deals may then be summarized and categorized in one or more visualizations by region, sales representative, customer, product, and/or product to help users determine areas they should focus on.

FIG. 4K depicts a deal details dashboard of graphical user interface 400 that may be displayed as part of a deal module of graphical user interface 400. In some embodiments, a deal details dashboard may include a scatterplot and filter functionality as described with respect to the deal performance dashboard shown in FIG. 4J. In some embodiments, a deal details dashboard may display specific deal information for a selected deal, such as ID, account name, channel, SKUs, list prices, discount prices, invoice revenues, pocket prices, and pocket margins.

One or both of the dashboards in the deals module may help users to identify anomalous deals, for example based on trends of discount given per deal and/or based on review of deal detail information displayed.

In some embodiments, the deals module may enable a user to apply one or more algorithms for new and repeat customer splits that analyze the data to identify patterns that are specific to new customers or specific to repeat customers.

FIGS. 4L-4Q depict dashboards of a customer module of graphical user interface 400. In some embodiments, a customer module may enable users to identify revenue and margin contributions of various accounts, which may help to classify low revenue/margin accounts over time. A customer module may give a quick view into possible price erosions over quarters and years.

FIG. 4L depicts a customer performance dashboard of graphical user interface 400 that may be displayed as part of a customer module of graphical user interface 400. A customer performance dashboard may provide an overview of customer performance information, and allow a user to view total revenue by region, trends (e.g., monthly trends), top/bottom customers (e.g., for invoice revenue, along with display of pocket margin, location, and/or trends for said top/bottom customers), and/or product-level drill-down information. A customer performance dashboard may show monthly trend information (or other temporal trend information) for a customer, which can help a user to identify seasonal changes in price elements and discount patterns. In some embodiments, seasonality in business-to-business use cases may be determined by the nature of product/service and/or client/customer financial year start and/or end dates. A customer performance dashboard may include a visualization of invoice revenue in a map view that may help users to localize the regions of improvement and allow users to use one or more filters to focus the analysis/visualization to specific regions.

FIG. 4M depicts a Pareto analysis dashboard of graphical user interface 400 that may be displayed as part of a customer module of graphical user interface 400. A Pareto analysis dashboard may include a Pareto chart of customer information. In some embodiments, the Pareto chart may be a Price and Revenue Pareto chart. In some embodiments, the Pareto chart may be a Pocket Margin Pareto chart. In some embodiments, a Pareto chart of customer information may be ranked by customers (e.g., by ranking/sorting customers based on a specified metric such as list price, invoice revenue, pocket price, and/or pocket margin) with the option to view the Pareto by list price, invoice revenue, pocket price, and/or pocket margin. In some embodiments, a Pareto analysis dashboard may visualize skewness of customer distribution and help users to identify any gap between percentage of accounts generating cumulative price and margins. In some embodiments, alternately or additionally to a Pareto chart of customer information, a Pareto chart of product information may be provided on this dashboard and/or on others.

FIG. 4N depicts a customer classification dashboard of graphical user interface 400 that may be displayed as part of a customer module of graphical user interface 400. In some embodiments, a customer classification dashboard may classify customers using a matrix visualization. In some embodiments, a customer classification dashboard may classify customers based on one or more client-specific and/or user-specified KPIs, and may pinpoint specific customers within each classification. In some embodiments, classification of customers may be based on one or both of revenue and margin. In some embodiments, a customer classification dashboard may provide functionality for a user to drill down to price components and/or margin for one or more accounts within a classification segment. In some embodiments, a customer classification dashboard may help users to classify customers into categories such as “Profit Builders,” “Contribution Customers,” “Average Joes,” and “Penalty Box” categories. In some embodiments, classification may be based on one or both of pocket margin and invoice revenue brackets. Classification in this manner may be useful for identifying customers for analysis and devising strategies to move them into other categories by increasing revenue or discount reductions.

FIG. 4O depicts a revenue/margin details dashboard of graphical user interface 400 that may be displayed as part of a customer module of graphical user interface 400. In some embodiments, a revenue/margin details dashboard may include a visualization that plots customers on a bubble chart by invoice revenue and margin percentage; users may be afforded the ability to select one or more specific customers via the chart to drill down to those one or more customers' specific deals with corresponding product details. In some embodiments, a revenue/margin details dashboard may shows trends of direct and/or indirect channel along the margins at account level, thereby pinpointing low performing accounts and their worst margin deals.

FIG. 4P depicts a revenue change by sales representative dashboard of graphical user interface 400 that may be displayed as part of a customer module of graphical user interface 400.

FIG. 4Q depicts a revenue change by customers dashboard of graphical user interface 400 that may be displayed as part of a customer module of graphical user interface 400. In some embodiments, these two dashboards may visualize revenue change by sales representative and by customers, respectively, for a base period and a comparison period. Further, the dashboards may allow users to select specific sales representatives or customers to drill down into granular data regarding the selected sales representative or customers. In some embodiments, these two dashboards may be useful for identifying consistent accounts and accounts with high differences between quarters/years.

In some embodiments, a customer module of graphical user interface 400 may include one or more visualizations, provided as a part of and/or separately from any of the above-described dashboards, of improvement by account type, such as by showing information and/or visualization of total improvement by account type and/or top accounts by improvement within each of one or more account types.

FIGS. 4R-4W depict dashboards of a product module of graphical user interface 400. In some embodiments, a customer module may enable users to identify price, revenue, and/or margin trends for one or more products.

FIG. 4R depicts a product performance dashboard of graphical user interface 400 that may be displayed as part of a product module of graphical user interface 400. In some embodiments, a product performance dashboard provides functionality for analyzing product family revenues and for drilling down to specific products (e.g., the product code level). For one or more user-selected products, the dashboard may display a customer mix visualization according to invoice revenue, and may highlight low-margin performing accounts. In some embodiments, the dashboard may allow a user to filter products according to one or more inputs, and may provide one or more visualizations of product family, SKUs, and/or account margins in a single view with intuitive forms of data presentation. In some embodiments, a product performance dashboard may enable users to evaluate product/customer mix based on performance of revenue and margin.

FIG. 4S depicts a product price variance dashboard of graphical user interface 400 that may be displayed as part of a product module of graphical user interface 400. A product price variance dashboard may comprise one of more visualizations that demonstrate SKU-level price variability, which may aid users in evaluating volume distribution by customizable price band. In some embodiments, a user may select a product family or product code via the dashboard, and the dashboard may display an indication and/or visualization of the price per unit distribution for the selected family or product by region, industry, channel, customer type, customer segment, partner tier, and/or sales representative. The dashboard may further display an indication and/or visualization of one or more revenue bands associated with the selected product family or product code, with functionality for re-calculation on the fly. In some embodiments, a price variance dashboard may include one or more box-and-whiskers visualizations. In some embodiments, a price variance dashboard may include one or more box-and-whiskers visualizations that are combined with price and volume bands, which may allow finding band-specific SKU list price anomalies for regions, channels, etc.

FIG. 4T depicts a product price and costs trends dashboard of graphical user interface 400 that may be displayed as part of a product module of graphical user interface 400. In some embodiments, a product price and costs trends dashboard may visualize product family revenue and may enable a user of the dashboard to execute one or more inputs to drill down to the product code level. With user-defined product selection, a customer mix by invoice revenue and low margin accounts can be displayed.

In some embodiments, a product price and costs trends dashboard may include a visualization that shows price fluctuations from transaction data alone. This price fluctuation visualization may displays SKU invoice revenue and indicates how much a SKU's List Price/Unit fluctuated within a selected time period. Price fluctuations may be measured by coefficient of variation. This visualization may be capable of changing price measure on the fly and dynamically calculating new price fluctuations at required granularity for the user-specified top percentile of SKUs.

FIG. 4U depicts a product profitability dashboard of graphical user interface 400 that may be displayed as part of a product module of graphical user interface 400. In some embodiments, a product profitability dashboard may include a list of one or more profitable product codes or families and/or a list of one or more unprofitable product codes or families. In some embodiments, a user may be able to select a product or family from a displayed list and the dashboard may responsively display a drill-down into one or more price waterfall elements for the selected product or family.

In some embodiments, a product profitability dashboard may include a combination of a visualization or display of SKU profitability with a visualization or display of a dynamic price waterfall for the SKU. These two visualizations, displayed together, may help a user to identify discount patterns for lower-margin SKUs.

FIG. 4V depicts a product channel price dashboard of graphical user interface 400 that may be displayed as part of a product module of graphical user interface 400. In some embodiments, a product channel price dashboard may visualize a comparison of one or more indirect channels versus one or more direct channels. For example, the visualization may compare percentage price differences between indirect channel price and direct channel price. In some embodiments, the dashboard may provide functionality for a user to drill down into one or more specific accounts.

In some embodiments, a product upsell dashboard may be provided as part of a product module of graphical user interface 400. In some embodiments, a product upsell dashboard may display information regarding product combinations for two or more products that are associated with one another, e.g., lays out the combination of products that are typically sold together which immediately helps identify the upselling opportunities for the client. For the product that has the maximum opportunity to be upsold, the dashboard also identifies top areas where this product should be upsold first based on the probability of purchase

FIG. 4W depicts a product upsell dashboard of graphical user interface 400 that may be displayed as part of a product module of graphical user interface 400. As shown in FIG. 4W, the product upsell dashboard may include a grid visualization that depicts respective sets of product families (or products) across two axes to form a grid. A first set of product families (and/or products) may be depicted across a horizontal axis, and a second set of product families (and/or products) may be depicted alone a vertical axis.

In some embodiments, the first and second set of product families may be the same set; in some embodiments, the first and second set may be different from one another. In some embodiments, the product families included in one or both of the first set and the second set may be predetermined by the system, may be dynamically/algorithmically/programmatically determined by the system (e.g., in accordance with upsell percentages or other metrics calculated by the system based on the ingested data), and/or may be determined in accordance with a user input executed via the product upsell dashboard, another dashboard in the product module, and/or another dashboard in a different module. In some embodiments, a user input selecting one or more product families for visualization by the product upsell dashboard may be executed by using a drop-down menu, typing into a field, clicking or tapping on a depicted product family, and/or entering an input specifying one or more characteristics or criteria for semi-automated selection of one or more product families for visualization by the product upsell dashboard.

As shown in FIG. 4W, the two axes correspond to columns and rows that form intersection regions on the visualization on the dashboard, wherein each of the intersection region corresponds to two product families—one from the horizontal axis and one from the vertical axis. The visualization may depict information and/or insights calculated by the system in the intersection region, where the information and/or insights depicted are associated with the two corresponding product families and is calculated based on ingested information associated with the two product families (and/or based on one or more criteria inputted by a user of the dashboard). In some embodiments, when the first and second set of product families include one or more overlapping product families, the intersection region corresponding the same product family along each axis may be blank, or may indicate that the region does not include any upsell information.

In some embodiments, the visualization may depict an association score for each intersecting region, wherein the association score is calculated by the system based on information ingested by the system and pertaining to the two product families. In some embodiments, the association score may be normalized in accordance with any suitable scheme, for example by being normalized to be a number between 0 and 1 or to be a percentage between 0% and 100%. In some embodiments, an association score may indicate a calculated likelihood that product families (and/or products, SKU's, etc., and/or a combination thereof) will be purchased together or in association with one another, with a higher score indicating a higher calculated likelihood.

In some embodiments, an association score may be calculated based on one or more Bayesian networks, based on overlap of customers for product families, and/or based on overlap of orders for product families. In some embodiments, an association score may be calculated as a quotient, wherein the numerator of the quotient represents an intersection (e.g., the intersection of the two product families) and the denominator of the quotient represents a union (e.g., the union of the two product families).

In some embodiments, the intersection region may include one or more textual and/or graphical representations of a calculated association score, including but not limited to a numerical depiction of the calculated score and/or a color-coding or shading associated with the calculated score. In some embodiments, higher association scores may be associated with a first set of one or more colors and/or with darker shading, while lower association scores may be associated with a second set of one or more colors and/or with lighter shading.

In some embodiments, the visualization depicted in the product upsell dashboard may be filtered according to region, channel, and/or account, for example in accordance with one or more inputs executed by a user (via the upsell dashboard and/or otherwise via the graphical user interface) specifying a region, channel, and/or account.

While the example shown in FIG. 4W shows product families across both axes, in some embodiments an upsell visualization may include one or more product families, one or more products, one or more product types, and/or one or more SKU's across one or more of the axes.

FIGS. 4X-4AC depict dashboards of a contra module of graphical user interface 400. In some embodiments, a contra module may enable users to assess effectiveness of off-invoice incentives by tracking rebates allocation, cash discounts, and/or cash incentives provided to channel partners.

In some embodiments, a contra module may include one or more dashboards that provide functionality for visualizing data relating to off-invoice incentives. Off-invoice incentives may vary in accordance with different geographies, different accounts, currency fluctuation, and additional factors. To improve margins and validate business strategies for a complex pricing feature, graphical user interface 400 includes the contra module, which may visualize one or more off-invoice components such as Market Development Funds (MDF), Rebates, and other off-invoice incentives. The contra module may provide guidelines for offering off-invoice incentives that are generated in accordance with analysis of the data. For example, with available transaction data and planned MDF and rebate data obtained from program documents, the system may generate planned amount paid out as incentive for different accounts, products, and/or programs. With client-provided actual payouts, a thorough comparison and analysis of return on investment (“ROI”) may then be conducted and visualized.

In some embodiments, a contra module may include one or more dashboards that provide functionality for visualizing data relating to MDF. In some embodiments, the contra module of graphical user interface 400 may leverage one or more input data sets and one or more parameterized data models to generate one or more of (a) contra summary data table information and (b) contra MDF information, one or more of which may be visualized by one or more of the dashboards of the contra module.

In some embodiments, a data union operation may be applied to generate the contra summary data table information. In some embodiments, the data union operation may be applied to one or more of the following data sets: transaction summary data, MDF data, rebates data, and off-invoice promotions data. In some embodiments, the data union operation may be applied using one or more of the following inputs: roll-up flag, schema auto-fill, and I/O name parameters. In some embodiments, one or more parameters for data union and output schema are defined, for example based on inputs provided via the contra module dashboards of graphical user interface 400.

In some embodiments, a data join operation may be applied to generate contra MDF data, which may be visualized by one or more dashboards of the contra module. In some embodiments, the data union operation may be applied to one or more of the following data sets: transaction summary data, MDF data, rebates data, and off-invoice promotions data. The data join operation may, in some embodiments, be applied using one or more of the following inputs: a roll-up flag, a join flag, and an I/O name parameter. In some embodiments, application of the data union operation may include defining one or more parameters to transform transaction data and MDF data, for example based on inputs provided via the contra module dashboards of graphical user interface 400.

One or more of the data join union and the data join operation may be applied as one or more data processing operations by system 104 of system 100.

FIG. 4X depicts a contra summary dashboard of graphical user interface 400 that may be displayed as part of a contra module of graphical user interface 400. In some embodiments, a contra summary dashboard may provide a high level view of spending on one or more of three channel incentives: MDF, rebates, and off-invoice special promotions. In some embodiments, the spending information may be displayed across various incentive types. In some embodiments, a contra summary dashboard may provide visualizations that monitors trends across time periods, top customers, and/or spend versus potential invoice revenue generated for distributors and/or resellers.

In some embodiments, a contra summary dashboard may provide an indication and/or visualization of overall contra payouts, and a user may thus may identifies peculiarities that the user can select for drill-downs in this dashboard and/or in other dashboards of interface 400.

In some embodiments, a contra summary dashboard may provide an indication of ROI (e.g., overall ROI) for MDF programs of a company, wherein the ROI may be calculated based on the underlying data sets. In some embodiments, the contra summary dashboard may provide functionality for one or more splits for the user to recalculate ROI and generate insights.

FIG. 4Y depicts a MDF performance summary dashboard of graphical user interface 400 that may be displayed as part of a contra module of graphical user interface 400. In some embodiments, an MDF performance summary dashboard may display information, based on the underlying data, that summarizes and/or visualizes MDF allocation and/or MDF spend to partners belonging to different regions, countries, and partner levels, across various activities and time-periods. In some embodiments, an MDF performance summary dashboard may provide functionality for calculating corresponding ROI values for a chosen timeframe.

FIG. 4Z depicts a distributor MDF assessment dashboard of graphical user interface 400 that may be displayed as part of a contra module of graphical user interface 400. In some embodiments, a distributor MDF assessment dashboard may enable users to analyze MDF allocated and MDF spent across various activities by monitoring and visualizing change (e.g., quarter-over-quarter change) in margin and/or other revenue metrics. In some embodiments, an activity assessment dashboard such as the distributor MDF assessment dashboard shown in FIG. 4AA may enable users to examine MDF spent distribution across activities and their correlation with invoice revenue generated. Said activity assessment dashboards may also display visualizations of MDF spent trends across time periods (e.g., quarters) and MDF spent by activity statuses, such that MDF can be redistributed across more effective activities.

In some embodiments, graphical user interface 400 may include additional dashboards for reseller MDF assessment, which may share one or more characteristics in common with the distributor MDF assessment dashboard shown in FIG. 4AA.

In some embodiments, a contra module may include one or more dashboards that provide functionality for visualizing data relating to rebates. Rebates are a type of sales promotion that marketers may use as incentives or supplements to product sales. They are a component of off-invoice incentives. In some embodiments, the contra module of graphical user interface 400 may leverage one or more input data sets and one or more parameterized data models to generate data regarding reallocated incentives at various granularities, which may be visualized as part of a merged data set by one or more of the dashboards of the contra module.

In some embodiments, a calculation operation may be applied to generate a new data set with planned off-invoice incentives. In some embodiments, the calculation may be applied to one or more of the following input data sets: transaction data, and planned off-invoice incentives (including one or more of growth rebate/incentive, volume rebate/incentive, retention rebate/incentive, and minimum/maximum rebate incentive). The calculation, in some embodiments, be applied using one or more of the following inputs (for example as specified by a user of a contra module): a time unit, a target definition, a level of detail, a number of tiers, a tier type, a payout definition, and a payout type. In some embodiments, performing the calculation may include defining one or more parameters (for example based on user inputs) to transform the input data sets and inputs into the new data set with planned off-invoice incentives.

The new data set generated by the calculation may then be used an input data set to a data join operation. The data join operation may also use one or more of the following data sets as input data sets: transaction data, and actual off-invoice incentives. The data join operation, in some embodiments, be applied using one or more of the following inputs (for example as specified by a user of a contra module): join keys, and rebate reallocation at a required granularity. In some embodiments, performing the data join operation may include defining one or more parameters (for example based on user inputs) to perform the data join. Based on the input data sets and input parameters, the data join operation may generate a data set (e.g., an insights dataset and/or a data set for tableau). In some embodiments, the generated data set resulting from the data join operation indicates reallocated incentives at different granularities. In some embodiments, the generated data set resulting from the data join operation and/or the reallocated incentives indicated thereby may be leveraged further via use through one or more deal analyses, customer analyses, product analyses, and/or margin computations.

This data set resulting from the data join operation may be visualized by one or more dashboards of a contra module, or may be used to generate one or more merged data sets that may then themselves be visualized by one or more dashboards of a contra module.

Any one or more of the functionalities described above regarding calculations, data join operations, data merging operations, and/or data visualization operations for rebate information for a contra module of graphical user interface 400 may be performed as one or more data processing operations by a system such as system 100.

Described below are dashboards of the contra module of graphical user interface 400 that pertain to rebates. As shown and described below, the rebates portion of the contra module may

Visualize comparisons amongst four rebate types at once, with the option to swap and arrange visualizations according to user input. The dashboards may provide options for visualizing splits, allowing a user to identify under-performing programs and to then drill down to selected accounts and/or products families within them. The dashboards may provide filtering functionalities that are applicable to multiple visualizations across multiple dashboards.

FIG. 4AA depicts a rebates performance summary dashboard of graphical user interface 400 that may be displayed as part of a contra module of graphical user interface 400.

In some embodiments, a rebates performance summary dashboard may provide an overview dashboard including a plurality of visualizations of rebates information that may enable users to identify peculiarities and examine them in detail in other rebates dashboards of graphical user interface 400. A rebates performance summary dashboard may show an indication and/or visualization of rebates paid out by direct or indirect channel, type of partners, and/or trend over time (e.g., over quarters). A rebates performance summary dashboard may show an indication and/or visualization of top compensated accounts, products, and/or programs.

FIG. 4AB depicts a rebates effectiveness by account dashboard of graphical user interface 400 that may be displayed as part of a contra module of graphical user interface 400. In some embodiments, a rebates effectiveness dashboard may be configured to display information regarding rebates effectiveness by account, rebates effectiveness by product or product family, and/or rebates effectiveness by program. In some embodiments, a rebates effectiveness dashboard may include an indication and/or visualization of a plurality (e.g., up to 10) rebate types, and may visualize a comparison of one or more trends for anomalous accounts, product families or products, and/or programs. In some embodiments, a rebates effectiveness dashboard may include a scatter plot visualization that depicts invoice revenue against payout (e.g., total amount paid as rebates), which may help users to identify over-compensated and under-compensated accounts and/or products. In some embodiments, a rebates effectiveness dashboard may include a visualization of change over time, such as a quarter-to-quarter change in invoice revenue versus change in payouts; this may help users to identify seasonal patterns and time periods for potential improvement. In some embodiments, a rebates effectiveness dashboard may be able to be customized in accordance with user inputs executed via the dashboard or via related dashboards in GUI 400 to filter for attributes such as region, channel, product, product family, account types, and/or account.

FIG. 4AC depicts a rebates category (planned versus actual) dashboard of graphical user interface 400 that may be displayed as part of a contra module of graphical user interface 400. In some embodiments, a rebates category (planned versus actual) dashboard may include a visualization of a plurality (e.g., four) of rebate types for actual versus planned payouts. In some embodiments, a rebates category dashboard may provide scenario analysis functionality, for example for testing hypotheses/strategies based on user inputs via rebate reduction sliders (e.g., inputs specifying parameters and/or thresholds) and visualization of the effects of said inputs; in some embodiments, said scenario analysis functionality for rebates may be provided by one or more separate dashboards of GUI 400.

FIGS. 4AD-4AH depict dashboards of a segmentation module of graphical user interface 400. In some embodiments, a segmentation module may comprise dashboards that may inform users regarding pricing decisions based on distinct segment profiles of customers, e.g., based on customer attributes such including historical purchasing data and calculated/predicted willingness to pay.

A segmentation module may leverage one or more segmentation operations (e.g., as applied by system 100) that categorizes customers (e.g., business-to-business customers) into different segments. The segments may be characterized in any suitable manner, such as by characterizing segments for “strategic buyers,” “value creators,” etc. The segmentation operation may be based on multiple attributes of customers' buying behavior and may leverage one or more transactional datasets. The segmentation operation may apply one or more data models that allow a user to select, define, and/or change attributes used for segmentation and select, define, and/or change final profiling variables (e.g., such that variables can be customized for different industries).

In some embodiments, a segmentation operation (e.g., a segmentation operation applied to data by a system such as system 100) may include applying a script (e.g., a script built on Apache Spark in Python) to derive attributes at an account level and/or a customer level. The operation may then include normalizing said derived attributes (e.g., to address and account for ay correlation between derived attributes). In some embodiments, normalization may be used to make different feature types comparable, such as revenue (e.g., dollars-based) and discount (e.g., percentage-based). The operation may then include applying an analysis algorithm such as Principal Component Analysis to reduce data-set dimensions. Then, the operation may include applying a clustering algorithm (e.g., a k-means clustering algorithm) to the results of the PCA in order to generate segmented data. Then, the operation may include applying a profiling operation to the segmented data. Then, the operation may include applying a white-space analysis operation. In some embodiments, the output of the segmentation operation may include one or more segment profiles, one or more accounts tagged with corresponding segments, and/or white-space analysis data. This output may be visualized by one or more dashboards of a segmentation module of graphical user interface 400.

FIG. 4AD depicts a data profile dashboard of graphical user interface 400 that may be displayed as part of a segmentation module of graphical user interface 400. In some embodiments, a data profile dashboard may indicate and/or visualize data summary organized by region, industry, channel, product, product family, account type, and/or end user category. An overview collated into this dashboard may give a user a concise picture of a company.

FIG. 4AE depicts a segments overview dashboard of graphical user interface 400 that may be displayed as part of a segmentation module of graphical user interface 400. In some embodiments, a segments overview dashboard may provide an indication and/or visualization of a plurality of customer segments identified in the data. With the custom designed navigation options, a user may use this dashboard as a launching pad to further drill down into a user-selected segment. The dashboard may allow a user to execute inputs to dynamically add one or more segments. The dashboard may allow a user to execute inputs to select one or more profiling variables to be used for one or more of the displayed visualizations.

FIG. 4AF depicts a matrix visualization dashboard of graphical user interface 400 that may be displayed as part of a segmentation module of graphical user interface 400. In some embodiments, a matrix visualization dashboard may visualize segmented entities in a matrix visualization, such as a 2×2 grid that organizes entities into four buckets.

In some embodiments, a matrix visualization may be based on invoice revenue along one axis and pocket margin along the other axis. In some embodiments, bubble size for an entity represented in the visualization may be based on a user-selected characteristic, such as number of orders, invoice revenue, pocket margin, quantity, list price, number of accounts, and/or willingness to pay (WTP). Users can execute one or more inputs to cause the dashboard to display account-level details, including WTP, for a selected segment. WTP may be calculated for a customer based on price paid by the customer for a product and a weighted average price of the product across all customers. Additionally or alternatively, willingness to pay may be calculated based on an actual price paid for a product, a minimum price for a product, and a maximum price for a product. In some embodiments, a matrix visualization dashboard may include user input options for parameterized cut-off values to define buckets according to how a user wants to classify and target segments.

FIG. 4AG depicts a segment details dashboard of graphical user interface 400 that may be displayed as part of a segmentation module of graphical user interface 400.

In some embodiments, a segment details dashboard may provide one or more visualizations of an account's performance dynamically as compared to a segment average into which the account is classified. The dashboard may shows indication and/or visualization of one or more SKUs by WTP and/or a quantity split across multiple parameters that can be selected based on user input executed via the interface. Using this dashboard, a user may be able to develop insights related to targeting the right products to accounts based on segment and WTP. For example, a user may be able to identify products with higher WTP that can be targeted to accounts with lower invoice revenue generation.

FIG. 4AH depicts a white-space analysis dashboard of graphical user interface 400 that may be displayed as part of a segmentation module of graphical user interface 400. In some embodiments, a white-space analysis dashboard may help identify gaps between characteristics of an entity and characteristics of a segment into which the entity is classified. In some embodiments, a white-space analysis dashboard may be powered by one or more separate modules that process segmentation output data to determine and visualize white space data. In some embodiments, a white-space analysis dashboard may display visualizations that characterize product buying pattern for customers in a particular segment and may indicate one or more opportunities for upsell for the customers.

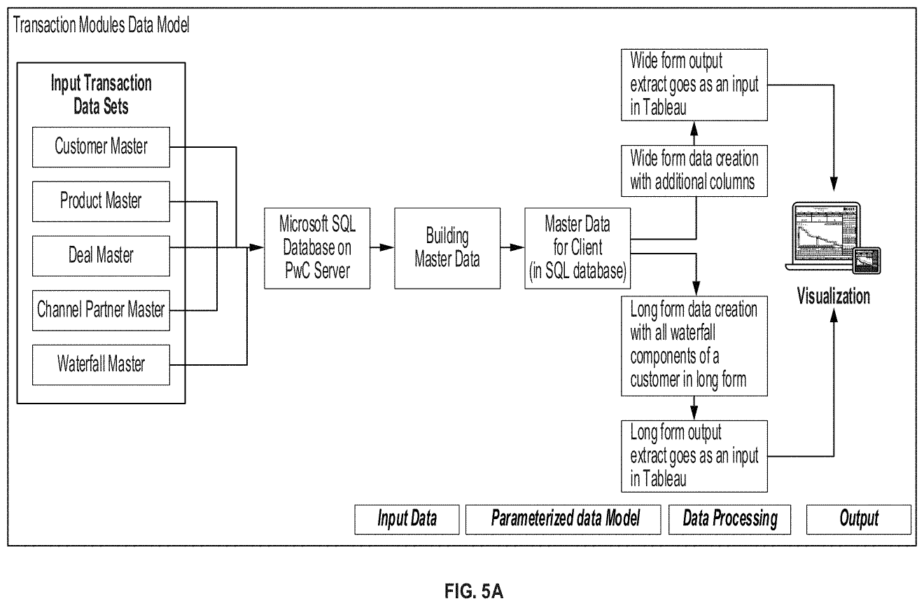

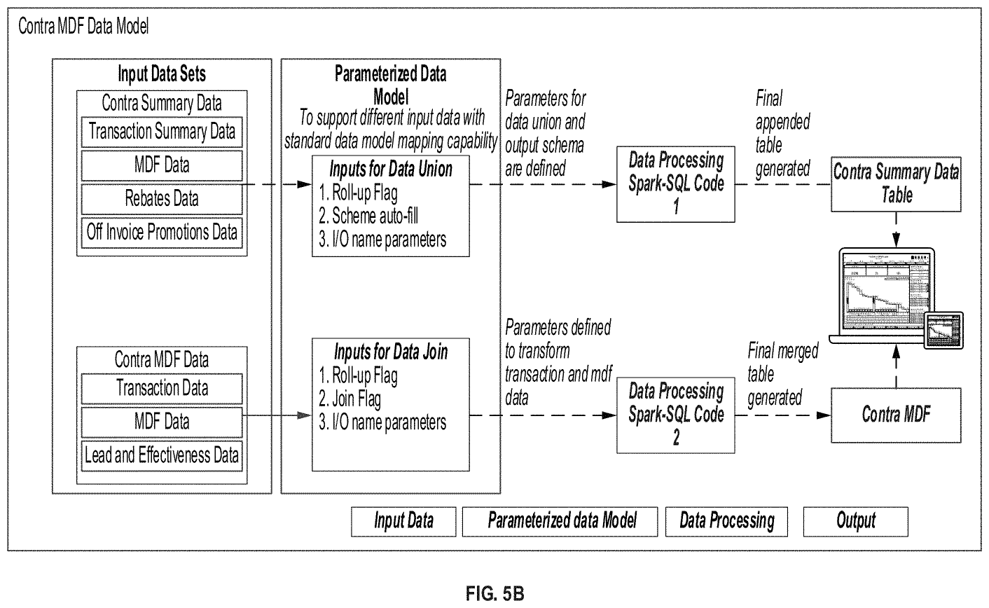

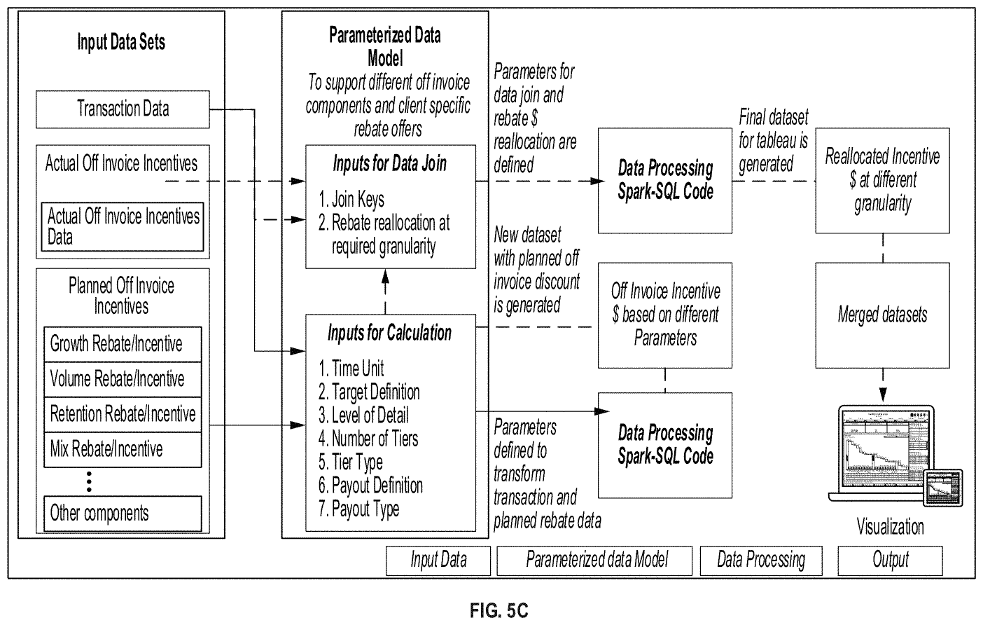

FIGS. 5A-5C depict data processing and visualization techniques, in accordance with some embodiments.

FIG. 5A depicts a data processing and visualization technique for ingesting and processing transaction data sets, in accordance with some embodiments. In some embodiments, the data processing and visualization process depicted in FIG. 5A may be leveraged by one or more modules of graphical user interface 400, including for example an executive module, an executive model, product module, customer module, and/or deals module. One or more of these modules may accept user inputs for controlling the technique depicted in FIG. 5A and/or may display a visualization generated by the technique depicted in FIG. 5A.

As shown in FIG. 5A, ingested data sets may include transaction data sets, such as customer master data, product master data, transaction master data, channel partner master data, rebate data, MDF data, and/or contra data. The ingested data sets may be aggregated and/or cleaned using one or more automated and/or interactive scripts that allow a user to customize the data processing actions. The data may then be mapped to a standard data form using one or more scripts that generate derived fields and/or prepare data for visualization. One or more scripts may ingest the data, map variables to an internal standard model (e.g., using a flexible user-defined data model defined in accordance with user inputs), and generate wide-form and long-form data tables for one or more modules. In some embodiments, wide-form data creation may include creating wide-form data with one or more additional columns. In some embodiments, long-form data creation may include creating long-form data with components for an entity (e.g., all price waterfall components for a customer) in long form. In some embodiments, the wide-form data and long-form data may each be used, alone and/or separately, for one or more visualizations as described herein.

FIG. 5B depicts a data processing and visualization technique for ingesting and processing contra data sets, in accordance with some embodiments. In some embodiments, the data processing and visualization process depicted in FIG. 5B may be leveraged by one or more modules of graphical user interface 400, including for example a contra module (including one or more MDF dashboards thereof). One or more of said modules may accept user inputs for controlling the technique depicted in FIG. 5B and/or may display a visualization generated by the technique depicted in FIG. 5B.

As shown in FIG. 5B, ingested data sets may include contra summary data, such as transaction summary data, MDF data, rebates data, and/or off-invoice promotions data. Ingested data sets may also include contra MDF data, including transaction summary data, MDF data, rebates data, and/or off-invoice promotions data.

In some embodiments, the ingested transaction summary data may be processed by a data union operation that may be applied using one or more of the following inputs: roll-up flag, schema auto-fill, and I/O name parameters. In some embodiments, one or more of the inputs and/or parameters for the data union operation may be defined by one or more user inputs, for example inputs executed via a GUI module. In some embodiments, the data union operation may generate contra summary data table data, which may be visualized by one or more of the modules.

In some embodiments, the ingested contra MDF data may be processed by a data join operation that may be applied using one or more of the following inputs: roll-up flag, join flag, and I/O name parameters. In some embodiments, one or more of the inputs and/or parameters for the data join operation may be defined by one or more user inputs, for example inputs executed via a GUI module. In some embodiments, the data join operation may generate contra MDF data, which may be visualized by one or more of the modules.

FIG. 5C depicts a data processing and visualization technique for ingesting and processing transaction data sets, off-invoice incentive data sets, and planned off-invoice incentive data sets, in accordance with some embodiments. In some embodiments, the data processing and visualization process depicted in FIG. 5C may be leveraged by one or more modules of graphical user interface 400, including for example a contra module (including one or more rebate dashboards thereof). One or more of said modules may accept user inputs for controlling the technique depicted in FIG. 5C and/or may display a visualization generated by the technique depicted in FIG. 5C.

In some embodiments, the contra module of graphical user interface 400 may leverage one or more input data sets and one or more parameterized data models to generate data regarding reallocated incentives at various granularities, which may be visualized as part of a merged data set by one or more of the dashboards of the contra module.

As shown in FIG. 5C, a calculation operation may be applied to generate a new data set with planned off-invoice incentives. In some embodiments, the calculation may be applied to one or more of the following input data sets: transaction data, and planned off-invoice incentives data (including one or more of growth rebate/incentive data, volume rebate/incentive data, retention rebate/incentive data, and minimum/maximum rebate incentive data). The calculation, in some embodiments, be applied using one or more of the following inputs (for example as specified by a user of a contra module): a time unit, a target definition, a level of detail, a number of tiers, a tier type, a payout definition, and a payout type. In some embodiments, performing the calculation may include defining one or more parameters (for example based on user inputs) to transform the input data sets and inputs into the new data set with planned off-invoice incentives.

As shown in FIG. 5C, the new data set generated by the calculation may then be used an input data set to a data join operation. The data join operation may also use one or more of the following data sets as input data sets: transaction data, and actual off-invoice incentives data. The data join operation, in some embodiments, be applied using one or more of the following inputs (for example as specified by a user of a contra module): join keys, and rebate reallocation at a required granularity. In some embodiments, performing the data join operation may include defining one or more parameters (for example based on user inputs) to perform the data join. Based on the input data sets and input parameters, the data join operation may generate a data set (e.g., an insights dataset and/or a data set for tableau). In some embodiments, the generated data set resulting from the data join operation indicates reallocated incentives at different granularities. In some embodiments, the generated data set resulting from the data join operation and/or the reallocated incentives indicated thereby may be leveraged further via use through one or more deal analyses, customer analyses, product analyses, and/or margin computations.

As shown in FIG. 5C, this data set resulting from the data join operation may be visualized (e.g., by one or more dashboards of a contra module), or may be used to generate one or more merged data sets that may then themselves be visualized (e.g., by one or more dashboards of a contra module).

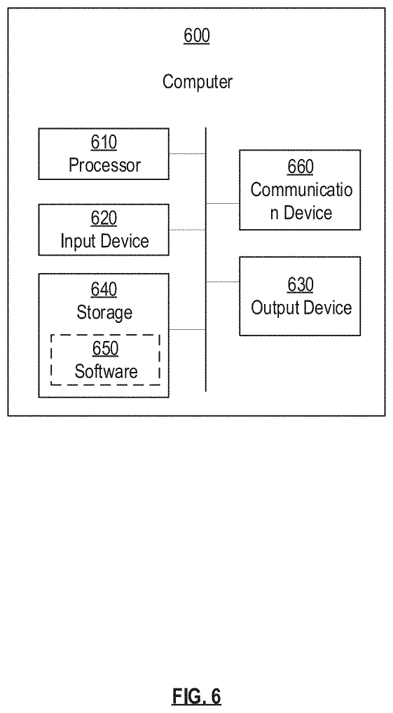

FIG. 6 illustrates an example of a computer, according to some embodiments. Computer 600 can be a component of a system according to the systems and methods described above, such as system 100 of FIG. 1, or can include the entire system itself. In some embodiments, computer 600 may execute all or part of a method for automated data set processing and visualization for multi-module pricing insights graphical user interface, such as any of the methods or techniques described herein.

Computer 600 can be a host computer connected to a network. Computer 600 can be a client computer or a server. As shown in FIG. 6, computer 600 can be any suitable type of microprocessor-based device, such as a personal computer, workstation, server, or handheld computing device, such as a phone or tablet. The computer can include, for example, one or more of processor 610, input device 620, output device 630, storage 640, and communication device 660. Input device 620 and output device 630 can correspond to those described above and can either be connectable or integrated with the computer.

Input device 620 can be any suitable device that provides input, such as a touch screen or monitor, keyboard, mouse, or voice-recognition device. Output device 630 can be any suitable device that provides an output, such as a touch screen, monitor, printer, disk drive, or speaker.

Storage 640 can be any suitable device that provides storage, such as an electrical, magnetic, or optical memory, including a random access memory (RAM), cache, hard drive, CD-ROM drive, tape drive, or removable storage disk. Communication device 660 can include any suitable device capable of transmitting and receiving signals over a network, such as a network interface chip or card. The components of the computer can be connected in any suitable manner, such as via a physical bus or wirelessly. Storage 640 can be a non-transitory computer-readable storage medium comprising one or more programs, which, when executed by one or more processors, such as processor 610, cause the one or more processors to execute all or part of one or more methods, including all or part of any one or more of the methods or techniques described herein.

Software 650, which can be stored in storage 640 and executed by processor 610, can include, for example, the programming that embodies the functionality of the present disclosure (e.g., as embodied in the systems, computers, servers, and/or devices as described above). In some embodiments, software 650 can include a combination of servers such as application servers and database servers.

Software 650 can also be stored and/or transported within any computer-readable storage medium for use by or in connection with an instruction execution system, apparatus, or device, such as those described above, that can fetch and execute instructions associated with the software from the instruction execution system, apparatus, or device. In the context of this disclosure, a computer-readable storage medium can be any medium, such as storage 640, that can contain or store programming for use by or in connection with an instruction execution system, apparatus, or device.

Software 650 can also be propagated within any transport medium for use by or in connection with an instruction execution system, apparatus, or device, such as those described above, that can fetch and execute instructions associated with the software from the instruction execution system, apparatus, or device. In the context of this disclosure, a transport medium can be any medium that can communicate, propagate, or transport programming for use by or in connection with an instruction execution system, apparatus, or device. The transport-readable medium can include but is not limited to, an electronic, magnetic, optical, electromagnetic, or infrared wired or wireless propagation medium.

Computer 600 may be connected to a network, which can be any suitable type of interconnected communication system. The network can implement any suitable communications protocol and can be secured by any suitable security protocol. The network can comprise network links of any suitable arrangement that can implement the transmission and reception of network signals, such as wireless network connections, T1 or T3 lines, cable networks, DSL, or telephone lines.

Computer 600 can implement any operating system suitable for operating on the network. Software 650 can be written in any suitable programming language, such as C, C++, Java, or Python. In various embodiments, application software embodying the functionality of the present disclosure can be deployed in different configurations, such as in a client/server arrangement or through a Web browser as a Web-based application or Web service, for example.

Unless defined otherwise, all terms of art, notations and other technical and scientific terms or terminology used herein are intended to have the same meaning as is commonly understood by one of ordinary skill in the art to which the claimed subject matter pertains. In some cases, terms with commonly understood meanings are defined herein for clarity and/or for ready reference, and the inclusion of such definitions herein should not necessarily be construed to represent a substantial difference over what is generally understood in the art.

As used herein, the singular forms “a,” “an,” and “the” are intended to include the plural forms as well, unless the context clearly indicates otherwise. It is also to be understood that the term “and/or” as used herein refers to and encompasses any and all possible combinations of one or more of the associated listed items. It is further to be understood that the terms “includes, “including,” “comprises,” and/or “comprising,” when used herein, specify the presence of stated features, integers, steps, operations, elements, components, and/or units but do not preclude the presence or addition of one or more other features, integers, steps, operations, elements, components, units, and/or groups thereof.

Any numerical ranges disclosed inherently support any range or value within the disclosed numerical ranges, including the endpoints, even though a precise range limitation is not stated verbatim in the specification because this disclosure can be practiced throughout the disclosed numerical ranges.

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying figures, it is to be noted that various changes and modifications will become apparent to those skilled in the art. Such changes and modifications are to be understood as being included within the scope of the disclosure and examples as defined by the claims.

1. A method for data ingestion for a data visualization platform, the method comprising:
receiving a plurality of data sets, wherein a first data set of the plurality of data sets is received from a first data source and wherein the second data set of the plurality of data sets is received from a second data source;
generating and store a merged data set based on the plurality of received data sets;
causing display of a graphical user interface configured to receive user instructions for data processing;
receiving, via the graphical user interface, a first input comprising an instruction to perform one or more data standardization operations;
in response to receiving the first input, applying the one or more data standardization operations to the merged data set to process the merged data set to generate a standardized data set;
receiving, via the graphical user interface, a second input comprising an instruction to perform one or more data analytics operations;
in response to receiving the second input, applying the one or more data analytics operations to the standardized data set to generate insights data;
receiving, via the graphical user interface, a third user input comprising an instruction to perform one or more data visualization operations; and
in response to receiving the third input, generating one or more data visualizations based on the insights data, wherein the data visualization includes an association visualization, wherein the association visualization depicts a plurality of association scores between a plurality of pairs of entities, wherein each of the plurality of pairs of entities includes a first entity in a first set of entities and a second entity in a second set of entities, and wherein the association visualization depicts a respective association score for each pair of the plurality of pairs of entities.

2. The method of claim 1, wherein:
the first input comprising an instruction to perform one or more data standardization operations comprises an instruction to perform a data mapping operation; and
applying the one or more data standardization operations comprises applying the data mapping operation to the merged data set.

3. The method of claim 2, wherein applying the data mapping operation to the merged data set comprises mapping one or more data objects in the merged data set to a predefined data format.

4. The method of claim 2, wherein:
the instruction to perform a data mapping operation comprises a specification of a characteristic of a user-defined data format; and
applying the data mapping operation to the merged data set comprises mapping one or more data objects in the merged data set to the user-defined data format in accordance with the specification of the characteristic of the user-defined data format.

5. The method of claim 4, wherein mapping one or more data objects in the merged data set to the user-defined data format comprises generating one or both of a wide-form data set and a long-form data set.

6. The method of claim 1, wherein applying the one or more data standardization operations comprises applying one or more roll-up operations to the merged data set.

7. The method of claim 1, wherein applying the one or more data standardization operations comprises applying one or more join operations to the merged data set.

8. The method of claim 1, wherein generating the merged data set based on the plurality of received data sets comprises applying one or more data cleaning operations one or more data objects in the plurality of received data sets.

9. The method of claim 1, wherein generating the merged data set based on the plurality of received data sets comprises applying one or more data aggregation operations to one or more data objects in the plurality of received data sets to join the plurality of data sets.

10. The method of claim 1, wherein applying the one or more data analytics operations comprises applying one or more segmentation operations to segment the merged data set.

11. The method of claim 1, wherein:
the second input comprises a selection of a predefined rule; and
applying the one or more data analytics operation comprises applying the predefined rule.

12. The method of claim 1, wherein:
the second input comprises an instruction to define a user-defined rule; and
applying the one or more data analytics operation comprises applying the user-defined rule.

13. The method of claim 1, the method further comprising:
receiving updated data for one or more of the plurality of data sets;
in response to receiving the updated data, automatically updating the one or more data visualizations based on the data insights data based on the received updated data.

14. The method of claim 1, the method further comprising:
receiving updated data for one or more of the plurality of data sets;
in response to receiving the updated data, automatically updating the merged data set based on the received updated data.

15. The method of claim 14, wherein receiving the updated data comprises performing a scheduled batch update operation.

16. The method of claim 1, wherein the first set of entities includes one or more product families, one or more products, or one or more SKU's.

17. The method of claim 1, wherein the second set of entities includes one or more product families, one or more products, or one or more SKU's.

18. The method of claim 1, wherein:
the first set of entities is depicted in the data visualization along a first axis,
the second set of entities is depicted in the data visualization along a second axis;
the first set of entities and the second set of entities define a plurality of intersecting regions in a grid; and
each of the plurality of intersection regions includes a respective depiction of a respective one of the association scores.

19. The method of claim 18, wherein the respective depictions include an alphanumeric depiction of the respective association score.

20. The method of claim 18, wherein the respective depiction includes one or more of a color-coding or a shading determined in accordance with the respective association score.

21. The method of claim 1, wherein one or more entities in the first set of entities or one or more entities in the second set of entities is selected in accordance with the third user input.

22. The method of claim 21, wherein the third user input indicates a criteria based on which the one or more entities in the first set of entities or one or more entities in the second set of entities is automatically selected.

23. The method of claim 1, wherein each association score is calculated based on one or more of customer overlap and order overlap.

24. The method of claim 1, wherein each association score is calculated as a respective quotient, wherein each quotient comprises a respective numerator representing an intersection of a respective pair of entities and each quotient comprises a respective denominator representing a union of the respective pair of entities.

25. A system for data ingestion for a data visualization platform, the system comprising one or more processors configured to cause the system to:
receive a plurality of data sets, wherein a first data set of the plurality of data sets is received from a first data source and wherein the second data set of the plurality of data sets is received from a second data source;
generate and store a merged data set based on the plurality of received data sets;
cause display of a graphical user interface configured to receive user instructions for data processing;
receive, via the graphical user interface, a first input comprising an instruction to perform one or more data standardization operations;
in response to receiving the first input, applying the one or more data standardization operations to the merged data set to process the merged data set to generate a standardized data set;
receiving, via the graphical user interface, a second input comprising an instruction to perform one or more data analytics operations;
in response to receiving the second input, applying the one or more data analytics operations to the standardized data set to generate insights data;
receiving, via the graphical user interface, a third user input comprising an instruction to perform one or more data visualization operations; and
in response to receiving the third input, generating one or more data visualizations based on the insights data, wherein the data visualization includes an association visualization, wherein the association visualization depicts a plurality of association scores between a plurality of pairs of entities, wherein each of the plurality of pairs of entities includes a first entity in a first set of entities and a second entity in a second set of entities, and wherein the association visualization depicts a respective association score for each pair of the plurality of pairs of entities.

26. A non-transitory computer-readable storage medium storing instructions for data ingestion for a data visualization platform, the instructions configured to be executed by one or more processors of a system to cause the system to:
receive a plurality of data sets, wherein a first data set of the plurality of data sets is received from a first data source and wherein the second data set of the plurality of data sets is received from a second data source;
generate and store a merged data set based on the plurality of received data sets;
cause display of a graphical user interface configured to receive user instructions for data processing;
receive, via the graphical user interface, a first input comprising an instruction to perform one or more data standardization operations;
in response to receiving the first input, applying the one or more data standardization operations to the merged data set to process the merged data set to generate a standardized data set;
receiving, via the graphical user interface, a second input comprising an instruction to perform one or more data analytics operations;
in response to receiving the second input, applying the one or more data analytics operations to the standardized data set to generate insights data;
receiving, via the graphical user interface, a third user input comprising an instruction to perform one or more data visualization operations; and
in response to receiving the third input, generating one or more data visualizations based on the insights data, wherein the data visualization includes an association visualization, wherein the association visualization depicts a plurality of association scores between a plurality of pairs of entities, wherein each of the plurality of pairs of entities includes a first entity in a first set of entities and a second entity in a second set of entities, and wherein the association visualization depicts a respective association score for each pair of the plurality of pairs of entities.

27. A system for data visualization, the system comprising:
memory storing a one or more data sets;
one or more processors configured to cause the system to:
cause display of a graphical user interface configured to accept user inputs for generating data visualizations;
detect a first input, executed via the graphical user interface, the first input comprising an instruction to display a first data visualization based on the data set,
in response to detecting the first user input, cause display via the graphical user interface of the first data visualization based on the data set,
wherein the graphical user interface comprises a graphical user interface module selected from the group of:
a first graphical user interface module configured to display information regarding pricing performance across a deal level, a customer level, and a product level represented in the one or more data sets;
a second graphical user interface module configured to display information regarding one or more deals represented in the one or more data sets;
a third graphical user interface module configured to display information regarding one or more customers represented in the one or more data sets;
a fourth graphical user interface module configured to display information regarding one or more products represented in the one or more data sets, wherein the fourth graphical user interface module is configured to display a data visualization including an association visualization, wherein the association visualization depicts a plurality of association scores between a plurality of pairs of entities, wherein each of the plurality of pairs of entities includes a first entity in a first set of entities and a second entity in a second set of entities, and wherein the association visualization depicts a respective association score for each pair of the plurality of pairs of entities;
a fifth graphical user interface module configured to display information regarding one or more off-invoice incentives represented in the data; and
a sixth graphical user interface module configured to display information regarding one or more customer segments represented in the data.

28. The system of claim 27, wherein the first graphical user interface module comprises one or more graphical user interface dashboards selected from the group of:
a data profile dashboard configured to display summary information displayed according to one or more of region, time period, product, family, channel, customer, and sales representative;
a price element benchmark dashboard configured to display one or more of price waterfall benchmark information and market development fund benchmark information;
a price waterfall and what-if analysis dashboard configured to accept scenario inputs from a user defining scenario constraints and to display a price waterfall visualization that is generated in accordance with the scenario inputs;
an insights dashboard configured to display information indicating one or more realization parameters calculated based on the one or more data sets and one or more user inputs; and
a discount analysis dashboard configured to display visualizations of one or more variations of discounts based on a plurality of categorical attributes.

29. The system of claim 27, wherein the second graphical user interface module comprises one or more graphical user interface dashboards selected from the group of:
a deal performance dashboard configured to accept deal parameter inputs and to generate a deal categorization visualization based on the deal parameter inputs; and
a deal details dashboard configured to accept deal filtering inputs and to generate a deal details visualization based on the deal filtering inputs.

30. The system of claim 27, wherein the third graphical user interface module comprises one or more graphical user interface dashboards selected from the group of:
a customer performance dashboard configured to display information, based on the one or more data sets, comprising one or more of total revenue by country for a customer, monthly trends for a customer, top customers, bottom customers, and product-level information for a customer;
a Pareto analysis dashboard configured to display a Pareto chart visualization for one or more of list price, invoice revenue, pocket price, and pocket margin, wherein the Pareto chart is generated based on the one or more data sets;
a customer classification matrix dashboard configured to display a matrix visualization of customer data, based on the one or more data sets, wherein the matrix visualization is generated in accordance with one or more key performance indicators;
a customer revenue/margin details dashboard configured to display a bubble chart based of customer data, based on the one or more data sets, wherein the bubble chart is generated in accordance with one or more of invoice revenue data and margin percentage data; and
a revenue change dashboard configured to display a visualization of revenue change data, based on the one or more data sets, for one or both of a sales representative and a customer.

31. The system of claim 27, wherein the fourth graphical user interface module comprises one or more graphical user interface dashboards selected from the group of:
a product performance dashboard configured to accept product selection inputs and to generate one or more product visualizations based on the one or more data sets and the product selection inputs;
a product price variance dashboard configured to display a price variability visualization based on the one or more data sets;
a product price and cost trends dashboard configured to display a product price and cost trends visualization, based on the one or more data sets, of one or more of price, cost, revenue, and fluctuations thereof for one or more products and;
a product profitability dashboard configured to display a profitability visualization, based on the one or more data sets;
a product channel price dashboard configured to display a channel visualization comparing one or more price metrics for a plurality of channels, wherein the channel visualization is generated based on the one or more data sets; and
a product upsell dashboard configured to display information indicating inter-product associations between two or more products, wherein said information indicating inter-product associations is based on the one or more data sets, wherein said information indicating inter-product associations includes the association visualization.

32. The system of claim 27, wherein the fifth graphical user interface module comprises one or more graphical user interface dashboards selected from the group of:
a contra summary dashboard configured to display market development fund summary information and rebate summary information, wherein the market development fund summary information and the rebate summary information are based on the one or more data sets;
a market development fund performance summary dashboard configured to display, based on the one or more data sets, one or both of market development fund allocation information and market development fund spend information;
a distributor market development fund assessment dashboard configured to display, based on the one or more data sets, one or both of market development fund allocation information and market development fund spend information for a distributor;
a distributor activity effectiveness dashboard configured to display, based on the one or more data sets, market development fund spend information across one or more activities for a distributor;
a reseller market development fund assessment dashboard configured to display, based on the one or more data sets, one or both of market development fund allocation information and market development fund spend information for a reseller;
a reseller activity assessment dashboard configured to display, based on the one or more data sets, market development fund spend information across one or more activities for a reseller;
a rebates performance summary dashboard configured to display, based on the one or more data sets, one or more of: rebate information pertaining to one or more channels, rebate information pertaining to one or more partners, rebate trend information for a time period, top compensated accounts, top compensated products, and top compensated programs;
a rebates effectiveness dashboard configured to display, based on the one or more data sets, a visualized comparison for a plurality of rebate types;
a rebates category dashboard configured to display, based on the one or more data sets, a visualized comparison for planned rebates versus actual rebates; and
a rebates scenario analysis dashboard configured to accept a rebate scenario input from a user and to generate and display, based on the one or more data sets and based on the rebate scenario input, a vitalization of rebate scenario information.

33. The system of claim 27, wherein the sixth graphical user interface module comprises one or more graphical user interface dashboards selected from the group of:
a data profile dashboard configured to display data summary information, based on the one or more data sets, wherein the data summary information is visualized in accordance with one or more of geography, country, industry, channel, product family, account type, and end user category;
a segments overview dashboard configured to accept one or more segments profiling inputs and to generate a segments profiling visualization, wherein the segments profiling visualization is based on the one or more data sets and on the one or more segments profiling inputs;
a segments matrix dashboard configured to display a segments matrix visualization that visualizes segments, based on the one or more data sets, in accordance with invoice revenue and pocket margin;
a segment details dashboard configured to display account-segment comparison information, based on the one or more data sets, wherein the account-segment comparison information compares at least one account to a segment into which the at least one account is categorized;
a white space analysis dashboard configured to display a white space visualization generated based on the one or more data sets.

34. A method for data visualization, the method performed at a system comprising a memory storing one or more data sets and comprising a processor, the method comprising:
causing display of a graphical user interface configured to accept user inputs for generating data visualizations;
detecting a first input, executed via the graphical user interface, the first input comprising an instruction to display a first data visualization based on the data set, in response to detecting the first user input, causing display via the graphical user interface of the first data visualization based on the data set,
wherein the graphical user interface comprises a graphical user interface module selected from the group of:
a first graphical user interface module configured to display information regarding pricing performance across a deal level, a customer level, and a product level represented in the one or more data sets;
a second graphical user interface module configured to display information regarding one or more deals represented in the one or more data sets;
a third graphical user interface module configured to display information regarding one or more customers represented in the one or more data sets;
a fourth graphical user interface module configured to display information regarding one or more products represented in the one or more data sets, wherein the fourth graphical user interface module is configured to display a data visualization including an association visualization, wherein the association visualization depicts a plurality of association scores between a plurality of pairs of entities, wherein each of the plurality of pairs of entities includes a first entity in a first set of entities and a second entity in a second set of entities, and wherein the association visualization depicts a respective association score for each pair of the plurality of pairs of entities;
a fifth graphical user interface module configured to display information regarding one or more off-invoice incentives represented in the data; and
a sixth graphical user interface module configured to display information regarding one or more customer segments represented in the data.

35. A non-transitory computer-readable storage medium storing instructions for data visualization, the instructions configured to be executed by one or more processors of a system comprising a memory storing one or more data sets, the instructions configured to cause the system to:
cause display of a graphical user interface configured to accept user inputs for generating data visualizations;
detect a first input, executed via the graphical user interface, the first input comprising an instruction to display a first data visualization based on the data set,
in response to detecting the first user input, cause display via the graphical user interface of the first data visualization based on the data set,
wherein the graphical user interface comprises a graphical user interface module selected from the group of:
a first graphical user interface module configured to display information regarding pricing performance across a deal level, a customer level, and a product level represented in the one or more data sets;
a second graphical user interface module configured to display information regarding one or more deals represented in the one or more data sets;
a third graphical user interface module configured to display information regarding one or more customers represented in the one or more data sets;
a fourth graphical user interface module configured to display information regarding one or more products represented in the one or more data sets, wherein the fourth graphical user interface module is configured to display a data visualization including an association visualization, wherein the association visualization depicts a plurality of association scores between a plurality of pairs of entities, wherein each of the plurality of pairs of entities includes a first entity in a first set of entities and a second entity in a second set of entities, and wherein the association visualization depicts a respective association score for each pair of the plurality of pairs of entities;
a fifth graphical user interface module configured to display information regarding one or more off-invoice incentives represented in the data; and
a sixth graphical user interface module configured to display information regarding one or more customer segments represented in the data.
